(19) United States
(12) Patent Application Publication
(10) Pub. No.: US 2023/0025201 A1
(43) Pub. Date: Jan. 26, 2023

(54) Multilayer Structure and Method for Producing Same, Packaging Material and Vacuum Insulator Including Same, and Protective Sheet for Electronic Device

(71) Applicant: KURARAY CO., LTD., Okayama (JP)

(72) Inventors: Shuhei Kuzume, Okayama (JP); Tatsuya Oshita, Tokyo (JP)

(73) Assignee: KURARAY CO., LTD., Okayama (JP)

(21) Appl. No.: 17/783,462

(22) PCT Filed: Dec. 9, 2020
(86) PCT No.: PCT/JP2020/045941

§ 371 Date: Jun. 8, 2022

(30) Foreign Application Priority Data
Dec. 10, 2019 (JP) 2019-222797

(51) Int. Cl. C08J 7/04; B65D 81/20; B05D 3/02; B05D 1/38; B05D 7/24

(52) U.S. Cl. CPC C08J 7/0423; B65D 81/2023; B05D 3/02; B05D 1/38; B05D 7/24; C08J 2329/04

(57) ABSTRACT

The present disclosure provides packaging materials and products including such as a multilayer structure comprising a base (X), a layer (Y), and a layer (Z), in which the layer (Y) and the layer (Z) are adjacently stacked in at least one pair of the layer (Y) and the layer (Z).

### TECHNICAL FIELD

The present invention relates to a multilayer structure and a method for producing same, packaging materials and vacuum insulators including same, and a protective sheet for electronic devices.

### BACKGROUND ART

Multilayer structures in which a gas barrier layer containing aluminum or aluminum oxide as a component is formed on a plastic film have been conventionally well-known. Such multilayer structures are used as, for example, packaging materials for protecting articles (such as foods) which are susceptible to quality change induced by oxygen, or a component of an electronic-device protective sheet, which is required to have gas barrier properties and water vapor barrier properties. The gas barrier layer is often formed on a plastic film by a dry process such as physical vapor deposition (PVD) or chemical vapor deposition (CVD). However, care must be taken in handling such a deposition film because the thin film of inorganic compound used for the gas barrier layer lacks flexibility, and becomes easily damaged when crumpled or bent, in addition to having poor adhesion to the base. This is particularly problematic in post-processes of a packaging material such as in printing, lamination, and bag formation, because the thin film develops cracks, and the gas barrier properties greatly decrease as a result of these processes.

In response to these issues, Patent Literature 1 describes a method that forms a flexible gas-barrier overcoat layer by coating a thin film of inorganic compound with a coating agent composed primarily of an aqueous solution or a mixed solution of water and alcohol containing a water-soluble polymer and at least one of (a) a metal alkoxide and/or a hydrolysate thereof and (b) tin chloride to improve gas barrier properties or produce a deposition-layer protective effect.

A more recent technique constructs a barrier layer through a process of applying a coating liquid. Patent Literature 2 discloses an invention intended to improve the physical stress resistance of a barrier layer obtained by using such a technique. In the invention described in Patent Literature 2, a layer including an aluminum atom is adjacently stacked with a layer containing a polymer having a plurality of phosphorus atoms, and a polymer having an ether bond but not having a glycosidic linkage. It is stated that this produces good interlayer adhesion even after retorting while maintaining high gas barrier properties even after exposure to physical stress such as stretching.

### CITATION LIST

### Patent Literature

Patent Literature 1: JPH 07(1995)-234947 A

Patent Literature 2: WO2016/103716

### SUMMARY OF INVENTION

### Technical Problem

However, when the conventional multilayer structures are used as packaging materials, there are cases where gas barrier properties cannot be sufficiently maintained when exposed to physical stress such as bending (hereinafter, also referred to simply as “bending”), or there are cases where appearance defects, such as delamination, occur when the multilayer structures are placed under severe conditions such as retorting (hereinafter, also referred to simply as “after retorting”).

It is accordingly an object of the present invention to provide a novel multilayer structure that has excellent gas barrier properties and excellent water vapor barrier properties, and that can maintain gas barrier properties and water vapor barrier properties even after bending, without developing appearance defects, such as delamination, after retorting. Another object of the present invention is to provide packaging materials and products including such a multilayer structure. It is yet another object of the present invention to provide an electronic-device protective sheet including the novel multilayer structure and having excellent gas barrier properties and excellent water vapor barrier properties, and capable of maintaining the barrier properties even after a damp heat test. Note that, the absence of appearance defects, such as delamination, after retorting may be described simply as “retort resistance”.

### Solution to Problem

Specifically, the present invention can achieve the foregoing objects with the following.
[1] A multilayer structure comprising a base (X), a layer (Y), and a layer (Z),

the layer (Y) and the layer (Z) being adjacently stacked in at least one pair of the layer (Y) and the layer (Z),

the layer (Y) containing a reaction product (D) of an aluminum atom-containing metal oxide (A) and an inorganic phosphorus compound (BI),

the layer (Z) containing a metal compound (R) containing a metal atom (M_{R}), and a hydroxyl group-containing resin (W),

the molar ratio M_{MR}/M_{AI} of the number of moles (M_{MR}) of metal atoms (M_{R}) to the number of moles (M_{AI}) of aluminum atoms per unit area in the layer (Y) and the layer (Z) being 0.0005 or more and 0.05 or less.
[2] The multilayer structure according to [1], wherein the hydroxyl group-containing resin (W) has at least a carbon atom, and the molar ratio M_{MR}/M_{C} of the number of moles (M_{MR}) of metal atoms (M_{R}) to the number of moles (Mc) of carbon atoms per unit area in the layer (Z) is 0.0007 or more and 0.07 or less.
[3] The multilayer structure according to [1] or [2], wherein the metal atom (M_{R}) comprises at least one selected from the group consisting of silicon, titanium, and zirconium.
[4] The multilayer structure according to any one of [1] to [3], wherein the metal compound (R) comprises at least one selected from the group consisting of a silicon compound (G) having a glycidyl group, an organotitanium compound (OT), and an organozirconium compound (OZ).
[5] The multilayer structure according to [4], wherein the silicon compound (G) having a glycidyl group is at least one compound represented by the following general formula (I),

Si(X₁)ₚZ_{q}R_{1(4-p-q)} (I),

wherein X₁ represents one selected from the group consisting of F, Cl, Br, I, R₂O—, R₃COO—, (R₄CO)₂CH—, and NO₃, Z represents an organic group having a glycidyl group, R₁, R2, R₃, and R₄ each independently represent a group selected from the group consisting of an alkyl group, an aralkyl group, an aryl group, and an alkenyl group, p represents an integer of 1 to 3, q represents an integer of 1 to 3, and 2≤(p+q)≤4, and wherein a plurality of X₁ may be the same or different when a plurality of X₁ exists, a plurality of Z may be the same or different when a plurality of Z exists, and a plurality of R₁ may be the same or different when a plurality of R₁ exists.
[6] The multilayer structure according to [5], wherein the silicon compound (G) having a glycidyl group is at least one selected from the group consisting of 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, and 2-(3,4-epoxycyclohexyl)ethyltriethoxysilane.
[7] The multilayer structure according to any one of [4] to [6], wherein the organotitanium compound (OT) is at least one selected from the group consisting of an organotitanium alkoxide, an organotitanium acylate, and an organotitanium chelate.
[8] The multilayer structure according to any one of [4] to [7], wherein the organozirconium compound (OZ) is at least one selected from the group consisting of an organozirconium alkoxide, an organozirconium acylate, and an organozirconium chelate.
[9] The multilayer structure according to any one of [1] to [8], wherein the hydroxyl group-containing resin (W) is polyvinyl alcohol.
[10] The multilayer structure according to any one of [1] to [9], wherein the mass ratio (W/R) of the hydroxyl group-containing resin (W) to the metal compound (R) in the layer (Z) is 2.0 or more and 200 or less.
[11] The multilayer structure according to any one of [1] to [10], which comprises a laminate structure in which the base (X), the layer (Y), and the layer (Z) are stacked in this order.
[12] The multilayer structure according to any one of [1] to [11], wherein the layer (Z) has an average thickness of 50 nm or more.
[13] The multilayer structure according to any one of [1] to [12], wherein the ratio (Z)/(Y) of an average thickness of the layer (Z) to an average thickness of the layer (Y) is 0.10 or more.
[14] A method for producing a multilayer structure of any one of [1] to [13], comprising:

a step (I) of applying a coating liquid (S) containing an aluminum atom-containing metal oxide (A), an inorganic phosphorus compound (BI), and a solvent to a base (X), and removing the solvent to form a precursor layer of layer (Y);

a step (II) of applying a coating liquid (T) containing a resin (W), the metal compound (R), and a solvent to the precursor layer of layer (Y), and removing the solvent to form a precursor layer of layer (Z); and

a step (III) of heat treating the precursor layer of layer (Y) and the precursor layer of layer (Z) to form a layer (Y) and a layer (Z).
[15] A packaging material comprising a multilayer structure of any one of [1] to [13].
[16] The packaging material according to [15], which is a vertical form-fill-seal bag, a vacuum packaging bag, a pouch, a laminated tube container, an infusion bag, a paper container, a strip tape, a container lid, or an in-mold labeled container.
[17] A vacuum insulator, wherein

the packaging material of [16] is a vacuum packaging bag,

the vacuum packaging bag comprises contents in an interior thereof,

the contents are a core material, and

the interior of the vacuum packaging bag has a reduced pressure.
[18] A protective sheet for electronic devices, comprising a multilayer structure of any one of [1] to [13].

### Advantageous Effects of Invention

According to the present invention, a novel multilayer structure can be provided that has excellent gas barrier properties and excellent water vapor barrier properties, and that can maintain gas barrier properties and water vapor barrier properties even after bending, without developing appearance defects, such as delamination, after retorting. The present invention can also provide packaging materials and products including such a multilayer structure. An electronic-device protective sheet also can be provided that includes the novel multilayer structure, and has excellent gas barrier properties and excellent water vapor barrier properties, and that is capable of maintaining the barrier properties even after a damp heat test.

### DESCRIPTION OF EMBODIMENTS

As used herein, “barrier properties” basically means both oxygen barrier properties and water vapor barrier properties (moisture permeability), and “gas barrier properties” basically means oxygen barrier properties. The property that provides excellent barrier properties even after bending may be described as “bending resistance”.

A multilayer structure of the present invention comprises a base (X), a layer (Y), and a layer (Z),

the layer (Y) and the layer (Z) being adjacently stacked in at least one pair of the layer (Y) and the layer (Z),

the layer (Y) containing a reaction product (D) of a metal oxide (A) and an inorganic phosphorus compound (BI),

the layer (Z) containing a metal compound (R) and a resin (W),

the molar ratio M_{MR}/M_{AI} of the number of moles (M_{MR}) of metal atoms (M_{R}) to the number of moles (M_{AI}) of aluminum atoms per unit area in the layer (Y) and the layer (Z) being 0.0005 or more and 0.05 or less.

In a multilayer structure of the present invention, the bending resistance and retort resistance tend to particularly improve with the layer (Z) containing a metal compound (R) and a resin (W), and with the molar ratio M_{MR}/M_{AI} of the number of moles (M_{MR}) of metal atoms (M_{R}) to the number of moles (M_{AI}) of aluminum atoms per unit area in the layer (Y) and the layer (Z) being 0.0005 or more and 0.05 or less.

Base (X)

The material of the base (X) is not particularly limited, and a base made of any of various materials can be used. Examples of the material of the base (X) include resins such as thermoplastic resins and thermosetting resins; fiber assemblies such as fabrics and paper; wood; glass; metals; and metal oxides. The base (X) preferably comprises a thermoplastic resin and a fiber assembly, and more preferably comprises a thermoplastic resin. The form of the base (X) is not particularly limited. The base (X) may be a laminar base such as a film or sheet. The base (X) is preferably one comprising at least one selected from the group consisting of a thermoplastic resin film, a paper layer, and an inorganic deposition layer (X′), more preferably one comprising a thermoplastic resin film. Even more preferably, the base (X) is a thermoplastic resin film.

Examples of thermoplastic resins that may be used in the base (X) include: polyolefin resins such as polyethylene and polypropylene; polyester resins such as polyethylene terephthalate (PET), polyethylene-2,6-naphthalate, polybutylene terephthalate, and copolymers thereof; polyamide resins such as nylon-6, nylon-66, and nylon-12; hydroxy group-containing polymers such as polyvinyl alcohol and ethylene-vinyl alcohol copolymer; polystyrene; poly(meth)acrylic acid esters; polyacrylonitrile; polyvinyl acetate; polycarbonate; polyarylate; regenerated cellulose; polyimide; polyetherimide; polysulfone; polyethersulfone; polyether ether ketone; and ionomer resins. The thermoplastic resin used for the base (X) is preferably at least one selected from the group consisting of polyethylene, polypropylene, polyethylene terephthalate, nylon-6, and nylon-66. More preferably, the thermoplastic resin is polyethylene terephthalate.

When a thermoplastic resin film is used as the base (X), the base (X) may be an oriented film or non-oriented film. In terms of high suitability for processes (such as printing and lamination) of the resulting multilayer structure, an oriented film, particularly a biaxially oriented film, is preferred. The biaxially oriented film may be a biaxially oriented film produced by any one method selected from simultaneous biaxial stretching, sequential biaxial stretching, and tubular stretching.

Examples of paper that may be used in the base (X) include kraft paper, high-quality paper, simili paper, glassine paper, parchment paper, synthetic paper, white paperboard, manila board, milk carton board, cup paper, and ivory paper. By using paper for the base (X), a multilayer structure for paper container can be obtained.

When the base (X) is in the form of a layer, the average thickness of the base (X) is preferably 1 to 1,000 μm, more preferably 5 to 500 μm, and even more preferably 9 to 200 μm, in terms of high mechanical strength and good processability of the resulting multilayer structure.

The inorganic deposition layer (X′) is typically a layer having barrier properties against oxygen and water vapor, and is preferably a layer having transparency. The inorganic deposition layer (X′) can be formed by vapor deposition of inorganic material. Examples of the inorganic material include metals (for example, aluminum), metal oxides (for example, silicon oxide, aluminum oxide), metal nitrides (for example, silicon nitride), metal oxynitrides (for example, silicon oxynitride), and metal carbonitrides (for example, silicon carbonitride). In view of excellence of transparency, the inorganic deposition layer (X′) is preferably one formed of aluminum oxide, silicon oxide, magnesium oxide, or silicon nitride.

The method of forming the inorganic deposition layer (X′) is not particularly limited, and the inorganic deposition layer (X′) can be formed by using, for example, a physical vapor deposition process such as vacuum vapor deposition (for example, resistance heating vapor deposition, electron beam deposition, molecular beam epitaxy, or ion plating), or sputtering (for example, dual magnetron sputtering); or a chemical vapor deposition process as thermochemical vapor deposition (for example, catalytic chemical vapor deposition), photochemical vapor deposition, plasma chemical vapor deposition (for example, a capacitively coupled plasma process, an inductively coupled plasma process, a surface wave plasma process, or an electron cyclotron resonance plasma process), atomic layer deposition, or organometallic vapor deposition.

The average thickness of inorganic deposition layer (X′) is preferably 0.002 to 0.5 μm, more preferably 0.005 to 0.2 μm, even more preferably 0.01 to 0.1 μm, though the average thickness depends on the type of components constituting the inorganic deposition layer. Within these ranges, the inorganic deposition layer (X′) can have a selected average thickness that provides good barrier properties and good mechanical characteristics to the multilayer structure. When the inorganic deposition layer (X′) has an average thickness of at least 0.002 μm, the inorganic deposition layer (X′) tends to have good barrier properties against oxygen and water vapor. When the average thickness of the inorganic deposition layer (X′) is 0.5 μm or less, the inorganic deposition layer (X′) tends to maintain barrier properties after bending.

Layer (Y)

The layer (Y) comprises a reaction product (D) of a metal oxide (A) and an inorganic phosphorus compound (BI). Because the layer (Y) serves as a barrier layer in a multilayer structure of the present invention, the barrier properties before bending tend to improve when the layer (Y) is provided in a multilayer structure of the present invention.

Aluminum Atom-Containing Metal Oxide (A)

The metal atoms constituting the metal oxide (A) (the metal atoms may be collectively referred to as “metal atoms (M)”) include at least one metal atom selected from atoms of metals belonging to Groups 2 to 14 of the periodic table, and include at least aluminum atoms. The metal atoms (M) preferably consist only of aluminum atoms. However, the metal atoms (M) may include aluminum atoms and other metal atoms. The metal oxide (A) may be a combination of two or more metal oxides (A). Examples of metal atoms other than aluminum atoms include metals in Group 2 of the periodic table, such as magnesium and calcium; metals in Group 12 of the periodic table, such as zinc; metals in Group 13 of the periodic table; metals in Group 14 of the periodic table, such as silicon; and transition metals such as titanium and zirconium. Silicon is categorized herein as a metal, although this element may be classified as a semimetal in other contexts. In view of good ease of handling and providing excellent gas barrier properties to the multilayer structure obtained, the metal atom (M) that can be used with aluminum is preferably at least one selected from the group consisting of titanium and zirconium.

The proportion of aluminum atoms in metal atoms (M) is preferably 50 mol % or more, more preferably 70 mol % or more, even more preferably 90 mol % or more, and may be 95 mol % or more. The metal atoms (M) may consist essentially of aluminum atoms. Examples of the metal oxide (A) include metal oxides produced by methods such as liquid-phase synthesis, gas-phase synthesis, and solid grinding.

The metal oxide (A) may be a hydrolytic condensate of a compound (E) containing a metal atom (M) to which a hydrolyzable characteristic group is bonded (hereinafter, also referred to simply as “compound (E)”). Examples of the characteristic group include halogen atoms, NO₃, an optionally substituted alkoxy group having 1 to 9 carbon atoms, an optionally substituted aryloxy group having 6 to 9 carbon atoms, an optionally substituted acyloxy group having 2 to 9 carbon atoms, an optionally substituted alkenyloxy group having 3 to 9 carbon atoms, an optionally substituted β-diketonato group having 5 to 15 carbon atoms, and a diacylmethyl group having an optionally substituted acyl group having 1 to 9 carbon atoms. A hydrolytic condensate of compound (E) can be regarded substantially as a metal oxide (A). Accordingly, a hydrolytic condensate of compound (E) is also referred herein to as “metal oxide (A)”. That is, the term “metal oxide (A)” as used herein is interchangeable with “hydrolytic condensate of compound (E)”, whereas the term “hydrolytic condensate of compound (E)” as used herein is interchangeable with “metal oxide (A)”.

Compound (E) Containing Metal Atom (M) to which Hydrolyzable Characteristic Group is Bonded

In view of ease of control of a reaction with the inorganic phosphorus compound (BI) and excellent gas barrier properties of the multilayer structure obtained, the compound (E) preferably comprises a compound (Ea) containing an aluminum atom (described later).

Examples of the compound (Ea) include aluminum chloride, aluminum nitrate, aluminum acetate, tris(2,4-pentanedionato)aluminum, trimethoxyaluminum, triethoxyaluminum, tri-n-propoxyaluminum, triisopropoxyaluminum, tri-n-butoxyaluminum, tri-sec-butoxyaluminum, and tri-tert-butoxyaluminum. Among these, triisopropoxyaluminum and tri-sec-butoxyaluminum are preferred. The compound (E) may be a combination of two or more compounds (Ea).

The compound (E) may comprise a compound (Eb) containing a metal atom (M), excluding aluminum. Examples of the compound (Eb) include titanium compounds such as tetrakis(2,4-pentanedionato)titanium, tetramethoxytitanium, tetraethoxytitanium, tetraisopropoxytitanium, tetra-n-butoxytitanium, and tetrakis(2-ethylhexoxy)titanium; and zirconium compounds such as tetrakis(2,4-pentanedionato)zirconium, tetra-n-propoxyzirconium, and tetra-n-butoxyzirconium. These may be used alone, or two or more thereof may be used in combination.

The proportion of the compound (Ea) in compound (E) is not particularly limited, and is, for example, preferably 80 mol % or more, more preferably 90 mol % or more, even more preferably 95 mol % or more, and may be 100 mol %.

The compound (E) is hydrolyzed, so that at least some of the hydrolyzable characteristic groups of the compound (E) are converted to hydroxy groups. The hydrolysate is then condensed to form a compound in which the metal atoms (M) are linked together via an oxygen atom (O). The repetition of this condensation results in the formation of a compound that can be regarded substantially as a metal oxide. The thus formed metal oxide (A), in general, has hydroxy groups present on its surface.

A compound is categorized herein as the metal oxide (A) when the ratio, [the number of moles of the oxygen atoms (O) bonded only to the metal atoms (M)]/[the number of moles of the metal atoms (M)], is 0.8 or more in the compound. The “oxygen atom (O) bonded only to the metal atom (M)”, as defined herein, refers to the oxygen atom (O) in the structure represented by M-O-M, and does not include an oxygen atom that is bonded to both the metal atom (M) and hydrogen atom (H) as is the case for the oxygen atom (O) in the structure represented by M-O—H. The above ratio in the metal oxide (A) is preferably 0.9 or more, more preferably 1.0 or more, and even more preferably 1.1 or more. The upper limit of this ratio is not particularly defined. When the valence of the metal atom (M) is denoted by n, the upper limit is typically expressed as n/2.

In order for the hydrolytic condensation to take place, it is important that the compound (E) has hydrolyzable characteristic groups. When there are no such groups bonded, hydrolytic condensation reaction does not occur or proceeds very slowly, which makes difficult the preparation of the metal oxide (A) intended.

The hydrolytic condensate of the compound (E) may be produced, for example, from a particular starting material by a technique employed in known sol-gel processes. As the starting material there can be used at least one selected from the group consisting of the compound (E), a partial hydrolysate of the compound (E), a complete hydrolysate of the compound (E), a compound formed by partial hydrolytic condensation of the compound (E), and a compound formed by condensation of a part of a complete hydrolysate of the compound (E).

The metal oxide (A) to be mixed with a material containing the inorganic phosphorus compound (BI) (inorganic phosphorus compound (BI), or a composition containing inorganic phosphorus compound (BI); described later) is preferably essentially free of phosphorus atoms.

Inorganic Phosphorus Compound (BI)

The inorganic phosphorus compound (BI) has a moiety capable of reacting with the metal oxide (A), and typically has a plurality of, preferably 2 to 20, such moieties. The moieties include a moiety capable of undergoing a condensation reaction with a functional group (e.g., hydroxy group) present on the surface of the metal oxide (A). Examples of such moieties include a halogen atom bonded directly to a phosphorus atom, and an oxygen atom bonded directly to a phosphorus atom. Typically, the functional group (e.g., hydroxy group) present on the surface of the metal oxide (A) is bonded to the metal atom (M) constituting the metal oxide (A).

Examples of the inorganic phosphorus compound (BI) include phosphorus oxoacids such as phosphoric acid, diphosphoric acid, triphosphoric acid, polyphosphoric acid formed by condensation of 4 or more molecules of phosphoric acid, phosphorous acid, phosphonic acid, phosphonous acid, phosphinic acid, and phosphinous acid; salts of these oxoacids (e.g., sodium phosphate); and derivatives of these oxoacids (e.g., halides such as phosphoryl chloride, and dehydration products such as phosphorus pentoxide). The inorganic phosphorus compound (BI) may be used alone, or two or more thereof may be used in combination. In view of improving the stability of coating liquid (S) (described later) and the gas barrier properties of the multilayer structure produced, phosphoric acid is preferably used alone or in combination with another inorganic phosphorus compound (BI). When phosphoric acid is used in combination with another inorganic phosphorus compound (BI), phosphoric acid preferably makes up 50 mol % or more of the total inorganic phosphorus compounds (BI).

Reaction Product (D)

The reaction product (D) is obtained by a reaction between the metal oxide (A) and the inorganic phosphorus compound (BI). A compound formed by a reaction between the metal oxide (A), the inorganic phosphorus compound (BI), and another compound is also categorized as the reaction product (D).

In an infrared absorption spectrum of the layer (Y), a maximum absorption wavenumber in the region from 800 to 1,400 cm⁻¹ is preferably 1,080 to 1,130 cm⁻¹. In the process in which the metal oxide (A) and the inorganic phosphorus compound (BI) react to form the reaction product (D), a metal atom (M) derived from the metal oxide (A) and a phosphorus atom (P) derived from the inorganic phosphorus compound (BI) are linked via an oxygen atom (O) to form a bond represented by M-O—P. As a result, a characteristic absorption band attributed to this bond appears in an infrared absorption spectrum of the reaction product (D). The multilayer structure exhibits good gas barrier properties when the characteristic absorption band attributed to the M-O—P bond is observed in the region from 1,080 to 1,130 cm⁻¹. The multilayer structure exhibits much better gas barrier properties particularly when the characteristic absorption band corresponds to the strongest absorption in the region from 800 to 1,400 cm⁻¹ where absorptions attributed to bonds between various atoms and oxygen atoms are generally observed.

By contrast, if a metal compound such as compound (E) or metal salt and the inorganic phosphorus compound (BI) are first mixed together and the mixture is then subjected to hydrolytic condensation, the resulting product is a composite material in which the metal atoms derived from the metal compound and the phosphorus atoms derived from the inorganic phosphorus compound (BI) have been almost homogeneously mixed and reacted. In this case, in an infrared absorption spectrum of the composite material, the maximum absorption wavenumber in the region from 800 to 1,400 cm⁻¹ falls outside the range of 1,080 to 1,130 cm⁻¹.

In the infrared absorption spectrum of the layer (Y), the width at half maximum of the maximum absorption band in the region from 800 to 1,400 cm⁻¹ is preferably 200 cm⁻¹ or less, more preferably 150 cm⁻¹ or less, even more preferably 100 cm⁻¹ or less, and particularly preferably 50 cm⁻¹ or less, in terms of the gas barrier properties of the resulting multilayer structure.

The infrared absorption spectrum of the layer (Y) can be measured by attenuated total reflection spectroscopy over the region of 800 to 1,400cm⁻¹, using a Fourier transform infrared spectrophotometer (Spectrum One, manufactured by Perkin Elmer, Inc.). If the measurement is not possible using this method, the measurement may be conducted by another method, examples of which include, but are not limited to: reflection spectroscopy such as reflection absorption spectroscopy, external reflection spectroscopy, or attenuated total reflection spectroscopy; and transmission spectroscopy such as Nujol method or pellet method performed on the layer (Y) scraped from the multilayer structure.

The layer (Y) may partially include a metal oxide (A) and/or an inorganic phosphorus compound (BI) not involved in the reaction.

In the layer (Y), the molar ratio between metal atoms constituting the metal oxide (A) and phosphorus atoms derived from the inorganic phosphorus compound (BI), as expressed by [metal atoms constituting metal oxide (A)]:[phosphorus atoms derived from inorganic phosphorus compound (BI)], is preferably 1.0:1.0 to 3.6:1.0, more preferably 1.1:1.0 to 3.0:1.0. With the molar ratio falling in these ranges, excellent gas barrier performance can be obtained. The molar ratio in the layer (Y) can be adjusted by adjusting the mixing ratio of the metal oxide (A) and the inorganic phosphorus compound (BI) in the coating liquid (S) used to form the layer (Y). The molar ratio in the layer (Y) is typically equal to that in the coating liquid (S).

The average thickness of the layer (Y) (or, for a multilayer structure including two or more layers (Y), the total average thickness of the layers (Y)) is preferably 0.05 to 4.0 μm, more preferably 0.1 to 2.0 μm. Thinning the layer (Y) provides a reduction in the dimensional change of the multilayer structure during a process such as printing or lamination. With a reduced thickness, the layer (Y) makes the multilayer structure more flexible, allowing the multilayer structure to have mechanical properties close to the mechanical properties of the base itself. When a multilayer structure of the present invention has two or more layers (Y), the average thickness of layer (Y) is preferably 0.05 μm or more in view of gas barrier properties. The average thickness of layer (Y) can be controlled by the concentration of the coating liquid (S) (described later) used to form the layer (Y), or by the method used to apply the coating liquid (S). The average thickness of the layer (Y) can be measured by observing a cross-section of the multilayer structure with a scanning electron microscope or transmission electron microscope.

Aside from the foregoing components, the layer (Y) may comprise a polymer (F) having at least one functional group selected from the group consisting of a carbonyl group, a hydroxyl group, a carboxyl group, a carboxylic acid anhydride group, and a salt of a carboxyl group. It is to be noted that the hydroxyl group-containing resin contained in the layer (Y) represents a polymer (F), whereas the hydroxyl group-containing resin contained in the layer (Z) represents a resin (W), though there is some redundancy between polymer (F) and resin (W).

Polymer (F)

The polymer (F) has at least one functional group selected from the group consisting of a carbonyl group, a hydroxyl group, a carboxyl group, a carboxylic acid anhydride group, and a salt of a carboxyl group. Preferably, the polymer (F) is a polymer having at least one functional group selected from the group consisting of a hydroxyl group and a carboxyl group.

Examples of the polymer (F) include polyethylene glycol; polyvinyl alcohol polymers such as polyvinyl alcohol, a modified polyvinyl alcohol containing 1 to 50 mol % of an α-olefin unit having at most 4 carbon atoms, and polyvinyl acetal (e.g., polyvinyl butyral); polysaccharides such as cellulose and starch; (meth)acrylic acid polymers such as polyhydroxyethyl (meth)acrylate, poly(meth)acrylic acid, and an ethylene-acrylic acid copolymer; and maleic acid polymers such as hydrolysates of an ethylene-maleic anhydride copolymer, hydrolysates of a styrene-maleic anhydride copolymer, and hydrolysates of an isobutylene-maleic anhydride alternate copolymer. Preferred are polyethylene glycol, and polyvinyl alcohol polymers. The preferred form of a polyvinyl alcohol polymer used as polymer (F) is the same as that of the resin (W) contained in the layer (Z).

The polymer (F) may be a homopolymer of a monomer having a polymerizable group, a copolymer of two or more monomers, or a copolymer of a monomer having at least one functional group selected from the group consisting of a carbonyl group, a hydroxyl group, a carboxyl group, a carboxylic acid anhydride group, and a salt of a carboxyl group, and a monomer having none of these groups. The polymer (F) may be a combination of two or more polymers (F).

The molecular weight of polymer (F) is not particularly limited. However, in order to obtain a multilayer structure having even better gas barrier properties and mechanical strength, the polymer (F) has a weight-average molecular weight of preferably 5,000 or more, more preferably 8,000 or more, even more preferably 10,000 or more. The upper limit of weight-average molecular weight of polymer (F) is not particularly limited, and may be, for example, 1,500,000 or less.

In view of maintaining the good appearance of the multilayer structure, the content of the polymer (F) in the layer (Y) is preferably less than 50 mass %, more preferably 20 mass % or less, even more preferably 10 mass % or less, and may be 0 mass %, relative to the mass of the layer (Y). The polymer (F) may or may not react with the components of the layer (Y).

The layer (Y) may additionally comprise other components. Examples of additional components of the layer (Y) include metal salts of inorganic acids, such as metal carbonates, metal hydrochlorides, metal nitrates, metal hydrogen carbonates, metal sulfates, metal hydrogen sulfates, and metal borates; metal salts of organic acids, such as metal oxalates, metal acetates, metal tartrates, and metal stearates; metal complexes such as a cyclopentadienyl metal complex (e.g., titanocene) and a cyanometal complex (e.g., Prussian blue); layered clay compounds; crosslinkers; polymer compounds other than the polymer (F); plasticizers; antioxidants; ultraviolet absorbers; and fire retardants. The content of the additional components in the layer (Y) of the multilayer structure is preferably 50 mass % or less, more preferably 20 mass % or less, even more preferably 10 mass % or less, particularly preferably 5 mass % or less, and may be 0 mass % (containing no additional components).

When the layer (Y) contains the polymer (F), the content of the reaction product (D) and the polymer (F) in the layer (Y) is preferably 70 mass % or more, more preferably 80 mass % or more, even more preferably 90 mass % or more, particularly preferably 95 mass % or more. The layer (Y) may consist essentially of the reaction product (D) and the polymer (F). When the layer (Y) is containing unreacted fractions of metal oxide (A) and inorganic phosphorus compound (BI), the content of the metal oxide (A), inorganic phosphorus compound (BI), reaction product (D), and polymer (F) in the layer (Y) preferably falls in these ranges.

Layer (Z)

The layer (Z) comprises a metal compound (R) and a resin (W), and the molar ratio M_{MR}/M_{AI} of the number of moles (M_{MR}) of metal atoms (M_{R}) to the number of moles (M_{AI}) of aluminum atoms per unit area in layer (Y) and layer (Z) is 0.0005 or more and 0.05 or less. The bending resistance and retort resistance tend to improve by the provision of the layer (Z) in a multilayer structure of the present invention. Though the reason for improved bending resistance and retort resistance is somewhat unclear, a possible explanation is the reaction (crosslinkage) between metal compound (R) and resin (W). The molar ratio M_{MR}/M_{AI} is preferably 0.0006 or more and 0.045 or less, more preferably 0.0007 or more and 0.042 or less, even more preferably 0.0009 or more and 0.040 or less. The method of calculation of molar ratio M_{MR}/M_{AI} is as described in the EXAMPLES section below.

Metal Compound (R)

The metal compound (R) is a compound including a metal atom (M_{R}). By containing the metal compound (R) in the layer (Z), the layer (Z) tends to be able to satisfy both bending resistance and retort resistance.

The metal atom (M_{R}) may be selected from any metal atoms. The metal atom (M_{R}) may be used alone, or two or more thereof may be used in combination. In view of further improvement of reactivity to the resin (W), the metal atom (M_{R}) preferably comprises at least one selected from the group consisting of silicon, titanium, and zirconium, and more preferably comprises at least one selected from the group consisting of silicon and titanium.

When the metal atom (M_{R}) is silicon, the metal compound (R) may be, for example, a silicon compound having relatively low reactivity to resin (W), such as an alkoxysilane, a halogensilane, a vinylsilane, or an alkylsilane, or may be, for example, a silicon compound having an organic group such as a glycidyl group, an amino group, an acryl group, an isocyanate group, or an mercapto group, and having relatively high reactivity to resin (W). In view of providing excellent bending resistance and excellent retort resistance, the metal compound (R) is preferably a silicon compound having high reactivity to resin (W), more preferably a silicon compound (G) having a glycidyl group (hereinafter, also referred to simply as “silicon compound (G)”).

In view of good reactivity to resin (W), the metal compound (R) preferably comprises at least one selected from the group consisting of a silicon compound (G), an organotitanium compound (OT), and an organozirconium compound (OZ), and more preferably comprises at least one selected from the group consisting of a silicon compound (G) and an organotitanium compound (OT). In view of good reactivity to resin (W), the metal compound (R) is preferably at least one selected from the group consisting of a silicon compound (G), an organotitanium compound (OT), and an organozirconium compound (OZ), more preferably at least one selected from the group consisting of a silicon compound (G) and an organotitanium compound (OT).

Preferably, the silicon compound (G) is at least one silicon compound represented by the following general formula (I).

Si(X₁)ₚZ_{q}R_{1(4-p-q)} (I),

wherein X₁ represents one selected from the group consisting of F, Cl, Br, I, R₂O—, R₃COO—, (R₄CO)₂CH—, and NO₃, Z represents an organic group having a glycidyl group, R₁, R₂, R₃, and R₄ each independently represent a group selected from the group consisting of an alkyl group, an aralkyl group, an aryl group, and an alkenyl group, p represents an integer of 1 to 3, q represents an integer of 1 to 3, and 2≤(p+q)≤4, and wherein a plurality of X₁ may be the same or different when a plurality of X₁ exists, a plurality of Z may be the same or different when a plurality of Z exists, and a plurality of R₁ may be the same or different when a plurality of R₁ exists.

For example, R₁, R₂, R₃, and R₄ are alkyl groups having 1 to 10 carbon atoms, aralkyl groups having 7 to 10 carbon atoms, aryl groups having 6 to 10 carbon atoms, or alkenyl groups having 2 to 9 carbon atoms, preferably alkyl groups having 1 to 6 carbon atoms, more preferably alkyl groups having 1 to 4 carbon atoms.

In formula (I), the glycidyl group in the organic group having an glycidyl group represented by Z contributes to formation (reaction) of a covalent bond with resin (W). Z in formula (I) may have only one glycidyl group, or may have a plurality of glycidyl groups.

In a preferred example, X₁ is a halogen atom or an alkoxy group (R₂O—) having 1 to 4 carbon atoms, Z is a C1 to C4 alkyl group having a glycidyl group, R¹ is an alkyl group having 1 to 4 carbon atoms, p is 2 or 3, q is 1 or 2, and 3≤(p+q)≤4. In a particularly preferred example, X₁ is a halogen atom or an alkoxy group (R₂O—) having 1 to 4 carbon atoms, Z is a C1 to C4 alkyl group having a glycidyl group, p is 3, and q is 1.

When the metal atom (M_{R}) is silicon, examples of the metal compound (R) include tetrachlorosilane, tetrabromosilane, tetramethoxysilane, tetraethoxysilane, methyltrimethoxysilane, ethyltrimethoxysilane, octyltrimethoxysilane, phenyltrimethoxysilane, vinyltrimethoxysilane, vinyltriethoxysilane, chlorotrimethoxysilane, chlorotriethoxysilane, dichlorodimethoxysilane, dichlorodiethoxysilane, trichloromethoxysilane, trichloroethoxysilane, vinyltrichlorosilane, 3-glycidoxypropyltrimethoxysilane, 3-glycidoxypropyltriethoxysilane, 3-glycidoxypropyltriisopropoxysilane, 3-glycidoxypropyltributoxysilane, 3-glycidoxypropyltrichlorosilane, 3-glycidoxypropylmethyldimethoxysilane, 3-glycidoxypropylmethyldiethoxysilane, 3-aminopropyltrimethoxysilane, 3-aminopropyltriethoxysilane, N-2(aminoethyl)-3-aminopropyltrimethoxysilane, N-2(aminoethyl)-3-aminopropylmethyldimethoxysilane, 2-(3,4-epoxycyclohexyl)ethyltrimethoxysilane, and 2-(3,4-epoxycyclohexyl)ethyltriethoxysilane. Preferred are 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, and 2-(3,4-epoxycyclohexyl)ethyltriethoxysilane, which all correspond to the silicon compound (G). More preferred is 3-glycidoxypropyltrimethoxysilane or 3-glycidoxypropyltriethoxysilane.

The organotitanium compound (OT) is preferably at least one selected from the group consisting of an organotitanium alkoxide, an organotitanium acylate, and an organotitanium chelate. Examples of the organotitanium compound (OT) include titanium lactate, and partially or completely neutralized products of titanium lactate (for example, ammonium salts of titanium lactate, such as monoammonium salts of titanium lactate, and diammonium salts of titanium lactate; sodium salts of titanium lactate, such as monosodium salts of titanium lactate, and disodium salts of titanium lactate; and potassium salts of titanium lactate, such as monopotassium salts of titanium lactate, and dipotassium salts of titanium lactate). Other examples include diisopropoxytitanium bis(triethanolaminate), di-n-butoxytitanium bis(triethanolaminate), diisopropoxytitanium bis(acetylacetonate), titanium tetrakis(acetylacetonate), polytitanium bis(acetylacetonate), tetraisopropoxytitanium, tetra-n-butoxytitanium, and titanium tetrastearate. Preferred are those having a chelate ligand and that are water soluble, specifically, titanium lactate, partially or completely neutralized products of titanium lactate, diisopropoxytitanium bis(triethanolaminate), and di-n-butoxytitanium bis(triethanolaminate). More preferred are titanium lactate, or partially or completely neutralized products of titanium lactate. Preferred as partially or completely neutralized products of titanium lactate are ammonium salts of titanium lactate.

The organozirconium compound (OZ) is preferably at least one selected from the group consisting of an organozirconium alkoxide, an organozirconium acylate, and an organozirconium chelate. Examples of the organozirconium compound (OZ) include zirconium dibutoxybis(ethyl acetonate)zirconium octylate compounds, zirconium stearate, zirconyl chloride compounds, and ammonium salts of zirconium lactate. Preferred are those that are water soluble, specifically, zirconyl chloride compounds, and ammonium salts of zirconium lactate.

When the metal compound (R) contains a silicon compound having an alkoxy group, it is preferable for even better bending resistance and retort resistance to include an additional step in which hydrolytic condensation is performed using a known sol-gel process by adding a solvent to the metal compound (R), and adding an acid catalyst and water to the resulting solution.

The metal compound (R) may be used alone, or two or more thereof may be used in combination.

Resin (W)

The resin (W) is a resin having a hydroxyl group. The bending resistance tends to improve by using resin (W). Preferably, the resin (W) is a hydrophilic resin, more preferably a water-soluble or water-dispersive resin. In view of increased hydrophilicity, the resin (W) preferably includes a monomer unit having a hydroxyl group. The content of the monomer unit having a hydroxyl group is preferably 30 mol % or more, more preferably 50 mol % or more, even more preferably 65 mol % or more, particularly preferably 90 mol % or more with respect to all monomer units constituting the resin (W). In the resin (W), the content of the monomer unit having a hydroxyl group may be 100 mass % or less, or 99.9 mass % or less with respect to all monomer units constituting the resin (W). The bending resistance tends to improve when the content of the monomer unit having a hydroxyl group in the resin (W) is confined in these ranges.

Examples of the resin (W) include hydroxyl group-containing epoxy resins, hydroxyl group-containing polyester resins, hydroxyl group-containing (meth)acrylic resins, hydroxyl group-containing polyurethane resins, vinyl alcohol resins, and polysaccharides. Preferably, the resin (W) contains a vinyl alcohol resin or a polysaccharide. In view of further improvement of retort resistance, the resin (W) more preferably contains a vinyl alcohol resin. Even more preferably, the resin (W) is a vinyl alcohol resin.

Examples of the vinyl alcohol resin include polyvinyl alcohol (hereinafter also referred to simply as “PVA”) resins, and ethylene-vinyl alcohol copolymer (hereinafter, also referred to simply as “EVOH”) resins. In view of bending resistance, the resin (W) is preferably a PVA resin. Examples of the PVA resin include PVA resins obtained through saponification after sole polymerization of a vinyl ester, and modified PVA resins having other modified groups. The modified PVA resins may be PVA resins modified via copolymerization, or may be PVA resins modified after polymerization reaction. Examples of the EVOH resins include EVOH resins obtained through saponification after copolymerization of a vinyl ester and ethylene, and modified EVOH resins having other modified groups. The modified EVOH resins may be EVOH resins modified via copolymerization, or may be EVOH resins modified after polymerization reaction. The vinyl alcohol resin may be used alone, or two or more thereof may be used as a mixture. In this specification, EVOH resins have an ethylene unit content of 20 mol % or more, and PVA resins have an ethylene unit content of less than 20 mol %.

The PVA resin has a degree of saponification of preferably 40 mol % or more, more preferably 50 mol % or more, even more preferably 70 mol % or more. The PVA resin may have a degree of saponification of 99.9 mol % or less. The adhesion to the layer (Y) tends to improve when the degree of saponification is 40 mol % or more. Preparation of a coating liquid (T) (described later) tends to be easier when the degree of saponification is 99.9 mol % or less. The degree of saponification of PVA resin can be calculated by measuring peak areas of hydrogen atoms contained in the vinyl ester structure and in the vinyl alcohol structure by ¹H-NMR measurement.

The EVOH resin has a degree of saponification of preferably 70 mol % or more, more preferably 80 mol % or more, even more preferably 90 mol % or more. The EVOH resin may have a degree of saponification of 99.9 mol % or less. The bending resistance tends to improve when the degree of saponification is adjusted to fall in these ranges. The EVOH resin may have an ethylene unit content of 20 mol % to 60 mol %. The ethylene unit content of EVOH resin is preferably 40 mol % or less, more preferably 30 mol % or less. When the ethylene unit content of EVOH resin is 60 mol % or less, the bending resistance tends to improve even more greatly. The degree of saponification of EVOH resin can be calculated by measuring peak areas of hydrogen atoms contained in the vinyl ester structure and in the vinyl alcohol structure by ¹H-NMR measurement.

When the vinyl alcohol resin has a modified group, examples of the modified group include a silanol group, a thiol group, an aldehyde group, a carboxy group, a sulfonic acid group, a nitrile group, and an amino group. Preferably, the vinyl alcohol resin has a silanol group.

When the vinyl alcohol resin is modified via copolymerization, examples of other monomers used for copolymerization with a vinyl ester include: olefins such as ethylene, propylene, isobutylene, α-octene, α-dodecene, and α-octadecene; hydroxyl group-containing α-olefins such as 3-buten-1-ol, 4-penten-1-ol, and 5-hexen-1-ol, and derivatives thereof such as acylated products of these; unsaturated acids such as acrylic acid, methacrylic acid, crotonic acid, maleic acid, maleic anhydride, itaconic acid, and undecylenic acid, and salts, monoesters, or dialkyl esters of these; nitriles such as acrylonitrile and methacrylonitrile; amides such as diacetoneacrylamide, acrylamide, and methacrylamide; olefin sulfonic acids such as ethylenesulfonic acid, allylsulfonic acid, and methallylsulfonic acid, or salts thereof; vinyl compounds such as alkyl vinyl ethers, dimethylallyl vinyl ketone, N-vinylpyrrolidone, vinyl chloride, vinylethylene carbonate, 2,2-dialkyl-4-vinyl-1,3-dioxnlan, glycerin monoallyl ether, and 3,4-diacetoxy-1-butene; substituted vinyl acetates such as isopropenyl acetate, and 1-methoxyvinyl acetate; vinylidene chloride; 1,4-diacetoxy-2-butene; and vinylene carbonate. When the vinyl alcohol resin contains other monomers such as above, the content of other monomers may be 10 mol % or less, 5 mol % or less, or 3 mol % or less.

The polysaccharides are preferably those having a molecular weight of 2,000 or more. Examples of the polysaccharides include starch, cellulose, or dextrin. Dextrin is preferred in view of ease of preparation of coating liquid (T) (described later). The starch may be a known starch, for example, such as amylose or amylopectin. The cellulose may be a known cellulose. However, because cellulose is normally insoluble in water, it is preferable that cellulose be dispersed in the coating liquid (T) (described later).

The resin (W) has a viscosity at 20° C. of preferably 1 mPa·s or more and 100 mPa·s or less, more preferably 3 mPa·s or more and 90 mPa·s or less, particularly preferably 5 mPa·s or more and 80 mPa·s or less as measured in a 4 mass % aqueous solution of resin (W) according to JIS K 6726 (1994). With the viscosity of resin (W) confined in these ranges, the layer (Z) can be more easily prepared into a uniform average thickness, and the multilayer structure produced tends to be able to repeatedly exhibit bending resistance in a stable fashion. The viscosity can be measured using a commercially available Brookfield rotary viscometer.

The molar ratio M_{MR}/M_{c} of the number of moles (M_{MR}) of metal atoms (M_{R}) to the number of moles (Mc) of carbon atoms per unit area in the layer (Z) is preferably 0.0007 or more, more preferably 0.002 or more, even more preferably 0.003 or more. The retort resistance tends to improve when the molar ratio M_{MR}/M_{C} is 0.0007 or more. The molar ratio M_{MR}/M_{C} is preferably 0.07 or less, more preferably 0.03 or less, even more preferably 0.015 or less. The bending resistance tends to improve when the molar ratio M_{MR}/M_{C} is 0.07 or less. The method of calculation of molar ratio M_{MR}/M_{C} is as described in the EXAMPLES section below.

The mass ratio (W/R) of hydroxyl group-containing resin (W) and metal compound (R) in the layer (Z) is preferably 2.0 or more, more preferably 4.0 or more, even more preferably 9.0 or more. The bending resistance tends to improve when the mass ratio (W/R) is 2.0 or more. The mass ratio (W/R) is preferably 200 or less, more preferably 90 or less, even more preferably 60 or less. The retort resistance tends to improve when the mass ratio (W/R) is 200 or less.

The layer (Z) may comprise other components to such an extent that addition of such additional components does not interfere with the effects of the present invention. Examples of additional components that may be contained in the layer (Z) include metal salts of inorganic acids, such as metal carbonates, metal hydrochlorides, metal nitrates, metal hydrogen carbonates, metal sulfates, metal hydrogen sulfates, and metal borates; metal salts of organic acids, such as metal oxalates, metal acetates, metal tartrates, and metal stearates; metal complexes such as a cyclopentadienyl metal complex (e.g., titanocene) and a cyanometal complex (e.g., Prussian blue); layered clay compounds; crosslinkers; polymer compounds other than the resin (W); plasticizers; antioxidants; ultraviolet absorbers; and fire retardants. The content of the additional components in the layer (Z) is preferably less than 10 mass %, more preferably less than 5 mass %, even more preferably less than 3 mass %, particularly preferably less than 1 mass %, and may be 0 mass % (containing no additional components). That is, the proportion of metal compound (R) and resin (W) in the layer (Z) is preferably 90 mass % or more, more preferably 95 mass % or more, even more preferably 99 mass % or more. The layer (Z) may consist essentially of metal compound (R) and resin (W), or may consist of metal compound (R) and resin (W). When the layer (Z) contains at least one selected from the group consisting of a silicon compound (G), an organotitanium compound (OT), and an organozirconium compound (OZ), the proportion of at least one selected from the group consisting of a silicon compound (G), an organotitanium compound (OT), and an organozirconium compound (OZ) in the layer (Z) is preferably 0.5 mass % or more, more preferably 0.8 mass % or more, even more preferably 1.5 mass % or more. The retort resistance tends to improve when the mass ratio is 0.5 mass % or more. The proportion of at least one selected from the group consisting of a silicon compound (G), an organotitanium compound (OT), and an organozirconium compound (OZ) in the layer (Z) is preferably 30 mass % or less, more preferably 20 mass % or less, even more preferably 17 mass % or less. The bending resistance tends to improve when the mass ratio is 30 mass % or less. The layer (Z) may contain a phosphorus atom. The proportion of phosphorus atoms is preferably 5 mol % or less, more preferably 3 mol % or less, even more preferably 1 mol % or less. Particularly preferably, the layer (Z) is essentially free of a phosphorus atom. The layer (Z) may contain the reaction product (D). The proportion of reaction product (D) is preferably 10 mol % or less, more preferably 5 mol % or less, even more preferably 1 mol % or less. Particularly preferably, the layer (Z) is essentially free of reaction product (D).

The layer (Z) can be formed using a known method, for example, such as printing (e.g., offset printing, gravure printing, or silkscreen printing), or coating (e.g., roll coating, knife edge coating, or gravure coating). The layer (Z) may be dried under common drying conditions.

The layer (Z) has an average thickness of preferably 50 nm or more, more preferably 60 nm or more, even more preferably 100 nm or more. The bending resistance tends to improve when the layer (Z) has an average thickness of 50 nm or more. The average thickness of layer (Z) can be measured using the method described in the EXAMPLES section below. The layer (Z) may have an average thickness of 3,000 nm or less, 1,000 nm or less, 500 nm or less, or 300 nm or less. Saturation tends to occur in the bending resistance improving effect of layer (Z) when the average thickness of layer (Z) is more than 3,000 nm. The molar ratio M_{MR}/M_{AI} of the number of moles (M_{MR}) of metal atoms (M_{R}) to the number of moles (M_{AI}) of aluminum atoms per unit area in layer (Y) and layer (Z) (described later) also can be adjusted by the average thickness of layer (Z).

The ratio (Z)/(Y) of the average thickness of layer (Z) to the average thickness of layer (Y) is preferably 0.10 or more, more preferably 0.15 or more, even more preferably 0.20 or more. The bending resistance tends to improve when the average thickness ratio of layer (Z) to layer (Y) is 0.10 or more. The average thickness ratio of layer (Z) to layer (Y) may be 1.5 or less.

Additional Layer (J)

A multilayer structure of the present invention may comprise an additional layer (J) to improve various properties (for example, heat sealing properties, barrier properties, mechanical characteristics). Such a multilayer structure of the present invention can be produced, for example, by stacking a layer (Y) on a base (X) (optionally, via an adhesive layer (I) described later), and, after stacking a layer (Z) on the layer (Y), bonding or forming the additional layer (J) either directly or via an adhesive layer (I) (described later). Examples of the additional layer (J) include, but are not limited to, an ink layer; and a thermoplastic resin layer such as a polyolefin layer, and an ethylene-vinyl alcohol copolymer resin layer.

When a multilayer structure of the present invention contains an ink layer, examples of the ink layer include a film resulting from drying of a liquid prepared by dispersing a polyurethane resin containing a pigment (e.g., titanium dioxide) in a solvent. The ink layer may be a film resulting from drying of an ink or electronic circuit-forming resist containing a polyurethane resin free of any pigment or another resin as a main component. Methods for applying the ink layer include gravure printing and various coating methods using a wire bar, a spin coater, or a die coater. The thickness of the ink layer is preferably 0.5 to 10.0 μm, more preferably 1.0 to 4.0 μm.

Placing a polyolefin layer as an outermost layer of the multilayer structure of the present invention can impart heat-sealing properties to the multilayer structure or improve the mechanical characteristics of the multilayer structure. In terms of, for example, the impartation of heat-sealing properties and the improvement in mechanical characteristics, the polyolefin is preferably polypropylene or polyethylene. It is also preferable to stack at least one film selected from the group consisting of a film made of a polyester, a film made of a polyamide, and a film made of a hydroxy group-containing polymer, in order to improve the mechanical characteristics of the multilayer structure. In terms of improvement of mechanical characteristics, the polyester is preferably polyethylene terephthalate, the polyamide is preferably nylon-6, and the hydroxy group-containing polymer is preferably ethylene-vinyl alcohol copolymer.

The additional layer (J) may be a layer formed by extrusion coating lamination. The extrusion coating lamination method that can be used in the present invention is not particularly limited, and known methods can be used. In a typical extrusion coating lamination method, a molten thermoplastic resin is fed to a T-die, and the thermoplastic resin is cooled into a laminate film as the resin discharges from a flat slit of the T-die.

Examples of extrusion coating lamination methods other than the single lamination described above include sandwich lamination and tandem lamination. The sandwich lamination is a method for producing a laminate by extruding a molten thermoplastic resin onto a first base supplied from an unwinder (feed roll), and bonding the extruded thermoplastic resin to a second base supplied from another unwinder. The tandem lamination is a method for producing a 5-layer laminate at once with two single-lamination machines used in tandem.

Adhesive Layer (I)

In a multilayer structure of the present invention, the adhesion between base (X) and layer (Y), or the adhesion to other members (for example, additional layer (J)) can be enhanced by using an adhesive layer (I). The adhesive layer (I) may be made of an adhesive resin. The adhesive resin that enhances the adhesion to other members is preferably a two-component reactive polyurethane adhesive including a polyisocyanate component and a polyol component which are to be mixed and reacted. Addition of a small amount of an additive such as a known silane coupling agent to the anchor coating agent or adhesive may further enhance the adhesion. Examples of the silane coupling agent include, but are not limited to, silane coupling agents having a reactive group such as an isocyanate, epoxy, amino, ureido, or mercapto group. By bonding other members, it may be possible to effectively prevent deterioration in the gas barrier properties or appearance of a multilayer structure of the present invention when the multilayer structure is subjected to a process such as printing or lamination. It may be also possible to increase the drop impact resistance of a packaging material including a multilayer structure of the present invention.

Aside from the above adhesive resin, it is preferable to use, for example, a polyester resin, a urethane resin, or a vinyl alcohol resin as the adhesive resin that improves the adhesion between base (X) and layer (Y). In view of improving the adhesion between base (X) and layer (Y), it is more preferable to use a vinyl alcohol resin, either alone or simultaneously with a polyester resin. The vinyl alcohol resin is preferably a PVA resin. Preferably, the PVA resin is of a form preferred as resin (W).

When a vinyl alcohol resin is used simultaneously with a polyester resin, the mass ratio (vinyl alcohol resin/polyester resin) is preferably 1/99 to 50/50, in view of maintaining good adhesion and providing even higher peel strength. In view of affinity to the vinyl alcohol resin, the polyester resin is preferably a polyester resin having a carboxyl group. When used as an adhesive, the polyester resin is preferably an aqueous dispersion. The affinity to the polyvinyl alcohol resin tends to improve when the polyester resin is an aqueous dispersion. The thickness of adhesive layer (I) is preferably 0.001 to 10.0 μm, more preferably 0.01 to 5.0 μm.

Configuration of Multilayer Structure

In a multilayer structure of the present invention, the layer (Y) and the layer (Z) are adjacently stacked in at least one pair of the layer (Y) and the layer (Z). Here, “adjacently stacked” means that the layer (Y) and the layer (Z) are directly stacked. By adjacently stacking the layer (Y) and the layer (Z), a multilayer structure of the present invention can more prominently exhibit bending resistance. Though the reason behind this is uncertain, the development of prominent bending resistance by the adjacently stacked layer (Y) and layer (Z) is probably a result of penetration of the components of layer (Z) into the surface of the layer (Y) or gaps present in the layer (Y). In view of further improvement of the bending resistance of a multilayer structure of the present invention, it is preferable that a multilayer structure of the present invention have a laminate structure in which the base (X), the layer (Y), and the layer (Z) are stacked in this order. The base (X) and the layer (Y) may be stacked to each other either directly or via adhesive layer (I).

Specific example configurations of a multilayer structure of the present invention are as follows. The configuration of each specific example may be a combination of more than one configuration of the same example. In the following specific examples, the base (X) and additional layer (J) are represented by names of specific resins. The order of layers (layer (Y)/layer (Z)) between layers represented by names of specific resins (between base (X) and additional layer (J)) may be reversed (layer (Z)/layer (Y)). Here, the symbol “I” means that the layers are laminated either directly or via an adhesive layer.

(1) Layer (Z)/layer (Y)/polyester layer (base (X))

(2) Layer (Z)/layer (Y)/polyester layer/layer (Y)/layer (Z)

(3) Layer (Z)/layer (Y)/polyamide layer

(4) Layer (Z)/layer (Y)/polyamide layer/layer (Y)/layer (Z)

(5) Layer (Z)/layer (Y)/polyolefin layer

(6) Layer (Z)/layer (Y)/polyolefin layer/layer (Y)/layer (Z)

(7) Layer (Z)/layer (Y)/hydroxyl group-containing polymer layer

(8) Layer (Z)/layer (Y)/hydroxyl group-containing polymer layer/layer (Y)/layer (Z)

(9) Layer (Z)/layer (Y)/paper layer

(10) Layer (Z)/layer (Y)/paper layer/layer (Y)/layer (Z)

(11) Layer (Z)/layer (Y)/inorganic deposition layer/polyester layer

(12) Layer (Z)/layer (Y)/inorganic deposition layer/polyamide layer

(13) Layer (Z)/layer (Y)/inorganic deposition layer/polyolefin layer

(14) Layer (Z)/layer (Y)/inorganic deposition layer/hydroxyl group-containing polymer layer

(15) Layer (Z)/layer (Y)/polyester layer/polyamide layer/polyolefin layer

(16) Layer (Z)/layer (Y)/polyester layer/layer (Y)/layer (Z)/polyamide layer/polyolefin layer

(17) Polyester layer/layer (Z)/layer (Y)/polyester layer/layer (Y)/layer (Z)/inorganic deposition layer/hydroxyl group-containing polymer layer/polyolefin layer

(18) Polyester layer/layer (Y)/layer (Z)/polyamide layer/polyolefin layer

(19) Layer (Z)/layer (Y)/polyamide layer/polyester layer/polyolefin layer

(20) Layer (Z)/layer (Y)/polyamide layer/layer (Y)/layer (Z)/polyester layer/polyolefin layer

(21) Polyamide layer/layer (Y)/layer (Z)/polyester layer/polyolefin layer

(22) Layer (Z)/layer (Y)/polyolefin layer/polyamide layer/polyolefin layer

(23) Layer (Z)/layer (Y)/polyolefin layer/layer (Y)/layer (Z)/polyamide layer/polyolefin layer

(24) Polyolefin layer/layer (Y)/layer (Z)/polyamide layer/polyolefin layer

(25) Layer (Z)/layer (Y)/polyolefin layer/polyolefin layer

(26) Layer (Z)/layer (Y)/polyolefin layer/layer (Y)/layer (Z)/polyolefin layer

(27) Polyolefin layer/layer (Z)/layer (Y)/polyolefin layer

(28) Layer (Z)/layer (Y)/polyester layer/polyolefin layer

(29) Layer (Z)/layer (Y)/polyester layer/layer (Y)/layer (Z)/polyolefin layer

(30) Polyester layer/layer (Y)/layer (Z)/polyolefin layer

(31) Layer (Z)/layer (Y)/polyamide layer/polyolefin layer

(32) Layer (Z)/layer (Y)/polyamide layer/layer (Y)/layer (Z)/polyolefin layer

(33) Polyamide layer/layer (Y)/layer (Z)/polyolefin layer

(34) Layer (Z)/layer (Y)/polyester layer/paper layer

(35) Layer (Z)/layer (Y)/polyamide layer/paper layer

(36) Layer (Z)/layer (Y)/polyolefin layer/paper layer

(37) Polyolefin layer/paper layer/polyolefin layer/layer (Y)/layer (Z)/polyester layer/polyolefin layer

(38) Polyolefin layer/paper layer/polyolefin layer/layer (Y)/layer (Z)/polyamide layer/polyolefin layer

(39) Polyolefin layer/paper layer/polyolefin layer/layer (Y)/layer (Z)/polyolefin layer

(40) Paper layer/polyolefin layer/layer (Y)/layer (Z)/polyester layer/polyolefin layer

(41) Polyolefin layer/paper layer/layer (Z)/layer (Y)/polyolefin layer

(42) Paper layer/layer (Z)/layer (Y)/polyester layer/polyolefin layer

(43) Paper layer/layer (Z)/layer (Y)/polyolefin layer

(44) Layer (Z)/layer (Y)/paper layer/polyolefin layer

(45) Layer (Z)/layer (Y)/polyester layer/paper layer/polyolefin layer

(46) Polyolefin layer/paper layer/polyolefin layer/layer (Z)/layer (Y)/polyolefin layer/hydroxyl group-containing polymer layer

(47) Polyolefin layer/paper layer/polyolefin layer/layer (Z)/layer (Y)/polyolefin layer/polyamide layer

(48) Polyolefin layer/paper layer/polyolefin layer/layer (Z)/layer (Y)/polyolefin layer/polyester layer

(49) Inorganic deposition layer/layer (Z)/layer (Y)/polyester layer

(50) Inorganic deposition layer/layer (Z)/layer (Y)/polyester layer/layer (Y)/layer (Z)/inorganic deposition layer

(51) Inorganic deposition layer/layer (Z)/layer (Y)/polyamide layer

(52) Inorganic deposition layer/layer (Z)/layer (Y)/polyamide layer/layer (Y)/layer (Z)/inorganic deposition layer

(53) Inorganic deposition layer/layer (Z)/layer (Y)/polyolefin layer

(54) Inorganic deposition layer/layer (Z)/layer (Y)/polyolefin layer/layer (Y)/layer (Z)/inorganic deposition layer

(55) Polyester layer/layer (Y)/layer (Z)/polyamide layer/inorganic deposition layer/hydroxyl group-containing polymer layer/polyolefin layer

(56) Polyamide layer/layer (Y)/layer (Z)/polyester layer/inorganic deposition layer/hydroxyl group-containing polymer layer/polyolefin layer

(57) Polyester layer/layer (Y)/layer (Z)/polyester layer/layer (Y)/layer (Z)/inorganic deposition layer/hydroxyl group-containing polymer layer/polyolefin layer

(58) Polyester layer/layer (Y)/layer (Z)/inorganic deposition layer/polyester layer/polyolefin layer

(59) Polyester layer/layer (Y)/layer (Z)/inorganic deposition layer/polyester layer/inorganic deposition layer/polyester layer/polyolefin layer

In these examples, the inorganic deposition layer is preferably a deposition layer of aluminum, and/or a deposition layer of aluminum oxide. In the foregoing examples, the hydroxyl group-containing polymer layer is preferably an ethylene-vinyl alcohol copolymer. In the foregoing examples, the polyolefin layer is preferably a polyethylene film or a polypropylene film. In the foregoing examples, the polyester layer is preferably a PET film. In the foregoing examples, the polyamide layer is preferably a nylon film.

Method of Production of Multilayer Structure

The features described for the multilayer structure of the present invention can be applied to the production method of the present invention and may not be described repeatedly. The features described for the production method of the present invention can be applied to the multilayer structure of the present invention.

A method for producing a multilayer structure of the present invention is, for example, a method that comprises:

a step (I) of applying a coating liquid (S) containing a metal oxide (A), an inorganic phosphorus compound (BI), and a solvent to a base (X), and removing the solvent to form a precursor layer of layer (Y);

a step (II) of applying a coating liquid (T) containing a metal compound (R), a resin (W), and a solvent to the precursor layer of layer (Y), and removing the solvent to form a precursor layer of layer (Z); and

a step (III) of heat treating the precursor layer of layer (Y) and the precursor layer of layer (Z) to form a layer (Y) and a layer (Z).

When producing a multilayer structure containing a polymer (F) in the layer (Y), the polymer (F) may be contained in the coating liquid (S) or in the coating liquid (T).

Step (I)

In step (I), a coating liquid (S) containing a metal oxide (A), an inorganic phosphorus compound (BI), and a solvent is applied to a base (X), and the solvent is removed to form a precursor layer of layer (Y). The coating liquid (S) can be obtained by mixing a metal oxide (A), an inorganic phosphorus compound (BI), and a solvent.

Examples of specific means of preparing the coating liquid (S) include a method that mixes a dispersion of metal oxide (A) with a solution containing inorganic phosphorus compound (BI), and a method that adds and mixes inorganic phosphorus compound (BI) into a dispersion of metal oxide (A). The temperature during the mixing is preferably 50° C. or less, more preferably 30° C. or less, even more preferably 20° C. or less. The coating liquid (S) may contain other compounds (for example, polymer (F)), and may optionally contain at least one acid compound (Q) selected from the group consisting of acetic acid, hydrochloric acid, nitric acid, trifluoroacetic acid, and trichloroacetic acid.

A dispersion of metal oxide (A) can be prepared, for example, by mixing compound (E), water, and optionally an acid catalyst or organic solvent, and allowing the compound (E) to undergo condensation or hydrolytic condensation according to procedures employed in known sol-gel processes. When a dispersion of metal oxide (A) is obtained by condensation or hydrolytic condensation of compound (E), the dispersion obtained may optionally be subjected to a certain process (such as deflocculation in the presence of the acid compound (Q)). The solvent used for the preparation of a dispersion of metal oxide (A) is preferably, but not limited to, an alcohol such as methanol, ethanol, or isopropanol, water, or a mixed solvent thereof.

The solvent used for the solution containing inorganic phosphorus compound (BI) can be selected as appropriate according to the type of inorganic phosphorus compound (BI), and the solvent preferably contains water. The solvent may contain an organic solvent (e.g., an alcohol such as methanol), as long as the organic solvent does not hinder the dissolution of inorganic phosphorus compound (BI).

The solids concentration in the coating liquid (S) is preferably 1 to 20 mass %, more preferably 2 to 15 mass %, and even more preferably 3 to 10 mass %, in terms of the storage stability of the coating liquid and the quality of application of the coating liquid onto the base. The solids concentration can be determined, for example, by distilling off the solvent from the coating liquid (S) and dividing the mass of the remaining solids by the initial mass of the coating liquid (S) yet to be subjected to the distillation.

The viscosity of the coating liquid (S) is preferably 3,000 mPa·s or less, more preferably 2,500 mPa·s or less, even more preferably 2,000 mPa·s or less, as measured with a Brookfield rotary viscometer (SB-type viscometer: rotor No. 3, rotational speed=60 rpm) at a temperature at which the coating liquid (S) is applied. Controlling the viscosity to 3,000 mPa·s or less improves the leveling of the coating liquid (S), thus allowing the resulting multilayer structure to have better appearance. The viscosity of the coating liquid (S) is preferably 50 mPa·s or more, more preferably 100 mPa·s or more, even more preferably 200 mPa·s or more.

The molar ratio of aluminum atoms and phosphorus atoms in the coating liquid (S), as expressed by [aluminum atoms]:[phosphorus atoms], is preferably 1.0:1.0 to 3.6:1.0, more preferably 1.1:1.0 to 3.0:1.0, particularly preferably 1.11:1.00 to 1.50:1.00. The molar ratio of aluminum atoms and phosphorus atoms can be determined by x-ray fluorescence analysis of a solid obtained by drying the coating liquid (S).

The method for application of the coating liquid (S) is not particularly limited, and any known method can be employed. Examples of the method for application include casting, dipping, roll coating, gravure coating, screen printing, reverse coating, spray coating, kiss coating, die coating, metering bar coating, chamber doctor-using coating, curtain coating, and bar coating.

The method of removing the solvent of the coating liquid (S) after the application of the coating liquid (S) (drying process) is not particularly limited, and known drying methods may be used. Examples of the drying methods include hot air drying, hot roll contact drying, infrared heating, and microwave heating.

The drying temperature is preferably below the onset temperature of fluidization of the base (X). The drying temperature after application of the coating liquid (S) may be, for example, about 60 to 180° C., and is more preferably 60° C. or more and less than 140° C., even more preferably 70° C. or more and less than 130° C., particularly preferably 80° C. or more and less than 120° C. . The drying time is not particularly limited, and is preferably at least 1 second and shorter than 1 hour, more preferably at least 5 seconds and shorter than 15 minutes, even more preferably at least 5 seconds and shorter than 300 seconds. When the drying temperature is 100° C. or more (for example, 100 to 140° C.), the drying time is preferably at least 1 second and shorter than 4 minutes, more preferably at least 5 seconds and shorter than 4 minutes, even more preferably at least 5 seconds and shorter than 3 minutes. When the drying temperature is below 100° C. (for example, 60 to 99° C.), the drying time is preferably at least 3 minutes and shorter than 1 hour, more preferably at least 6 minutes and shorter than 30 minutes, even more preferably at least 8 minutes and shorter than 25 minutes. With the drying conditions of coating liquid (S) confined in these ranges, the multilayer structure obtained tends to have even better gas barrier properties. A precursor layer of layer (Y) is formed upon removing solvent through this drying process.

Step (II)

In step (II), a coating liquid (T) containing a metal compound (R), a resin (W), and a solvent is applied to the precursor layer of layer (Y) obtained in step (I), and the solvent is removed to form a precursor of layer (Z).

The coating liquid (T) can be prepared, for example, by a method in which a liquid containing a metal compound (R) and a solvent is added to a liquid containing a resin (W) and a solvent, or by a method in which a solvent is added to a metal compound (R), and an acid catalyst and water are added to the resulting solution to allow hydrolytic condensation according to a known sol-gel process, and the hydrolytic condensate produced is added to a solution containing a resin (W) and a solvent. The solvent used for the coating liquid (T) is preferably, but not limited to, an alcohol such as methanol, ethanol, or isopropanol, water, or a mixed solvent thereof.

The acid catalyst used for the method involving hydrolytic condensation may be a known acid, for example, such as hydrochloric acid, sulfuric acid, nitric acid, p-toluenesulfonic acid, benzoic acid, acetic acid, lactic acid, butyric acid, carbonic acid, oxalic acid, or maleic acid. Particularly preferred are hydrochloric acid, sulfuric acid, nitric acid, acetic acid, lactic acid, and butyric acid. The amount of acid catalyst used depends on the type of the acid used, and is preferably 1×10⁻⁵ to 10 moles, more preferably 1×10⁻⁴ to 5 moles, even more preferably 5×10⁻⁴ to 1 mole per mole of metal atoms in the metal compound (R).

The amount of water used in the method involving hydrolytic condensation depends on the type of the metal compound (R) used, and is preferably 0.05 to 10 moles, more preferably 0.1 to 5 moles, even more preferably 0.2 to 3 moles per mole of hydrolyzable characteristic groups in the metal compound (R) used in step (II).

The temperature in the preparation of coating liquid (T) in step (II) is not particularly limited, and typically ranges from 2 to 100° C., preferably 4 to 60° C., more preferably 5 to 40° C. The time depends on the amount and type of resin (W), metal compound (R), and solvent. When the method involves hydrolytic condensation, the time varies with reaction conditions (e.g., the amount and type of acid catalyst). Typically, the time is 0.01 to 60 hours, preferably 0.1 to 12 hours, more preferably 0.1 to 6 hours. The coating liquid (T) may be prepared in an atmosphere of a gas, for example, such as air, carbon dioxide, nitrogen, or argon.

The solids concentration of coating liquid (T) is preferably 0.01 to 10 mass %, more preferably 0.05 to 7 mass %, even more preferably 0.1 to 5 mass %, in terms of the storage stability of the coating liquid and the quality of application of the coating liquid onto the base. The solids concentration can be determined, for example, by distilling off the solvent from the coating liquid (T) and dividing the mass of the remaining solids by the initial mass of the coating liquid (T) yet to be subjected to the distillation.

The method of applying the coating liquid (T) is not particularly limited, and known methods may be used. Examples of application methods include casting, dipping, roll coating, gravure coating, screen printing, reverse coating, spray coating, kiss coating, die coating, metering bar coating, chamber doctor-using coating, curtain coating, and bar coating.

The thickness of the layer (Z) formed after the application of the coating liquid (T) to the precursor layer of layer (Y) can be controlled by the solids concentration of coating liquid (T) or by the application method. For example, in the case of gravure coating, the thickness of the layer (Z) can be controlled by varying the cell volume of a gravure roll.

The method of removing the solvent of the coating liquid (T) after the application of the coating liquid (T) to the base (X) is not particularly limited, and known drying methods may be used. Examples of the drying methods include hot air drying, hot roll contact drying, infrared heating, and microwave heating.

Step (III)

In step (III), the precursor layer of layer (Y) and the precursor layer of layer (Z) formed in step (II) are heat treated to form a layer (Y) and a layer (Z). In step (III), a reaction proceeds that produces a reaction product (D), and a reaction occurs between metal compound (R) and resin (W). For the reaction to sufficiently proceed, the heat-treatment temperature is preferably 140° C. or more, more preferably 170° C. or more, even more preferably 180° C. or more, particularly preferably 190° C. or more. Low heat-treatment temperatures lead to decreased productivity because the time required to produce a sufficient reaction rate increases as the heat-treatment temperature decreases. The heat-treatment temperature depends on factors such as the type of base (X), and the heat-treatment temperature is preferably 270° C. or less when, for example, a thermoplastic resin film made of polyamide resin is used as base (X). When a thermoplastic resin film made of polyester resin is used as base (X), the heat-treatment temperature is preferably 240° C. or less. The heat treatment may be carried out, for example, in an air atmosphere, a nitrogen atmosphere, or an argon atmosphere. The heat-treatment time is preferably 1 second to 1 hour, more preferably 1 second to 15 minutes, even more preferably 5 to 300 seconds.

It is preferable that step (III) include a first heat-treatment step (III-1) and a second heat-treatment step (III-2). When the heat treatment is performed in two or more stages, it is preferable that the temperature of the heat treatment in the second stage (hereinafter, “second heat treatment) be higher than the temperature of the heat treatment in the first stage (hereinafter, first heat treatment). More preferably, the temperature of the second heat treatment is higher than the temperature of the first heat treatment by at least 15° C., even more preferably by at least 20° C., particularly preferably by at least 30° C.

In view of providing a multilayer structure having good properties, it is preferable that the heat-treatment temperature (a first heat-treatment temperature when the heat treatment is performed in two or more stages) in step (III) be higher than the drying temperature of step (II), preferably by at least 30° C., more preferably by at least 50° C., even more preferably by at least 55° C., particularly preferably by at least 60° C.

When the heat treatment in step (III) is performed in two or more stages, it is preferable that the temperature of the first heat treatment be 140° C. or more and less than 200° C., and that the temperature of the second heat treatment be 180° C. to 270° C. Preferably, the temperature of the second heat treatment is higher than the first heat-treatment temperature. More preferably, the temperature of the second heat treatment is higher than the first heat-treatment temperature by at least 15° C., even more preferably by at least 25° C. When the heat-treatment temperature is 200° C. or higher, the heat-treatment time is preferably 0.1 seconds to 10 minutes, more preferably 0.5 seconds to 5 minutes, even more preferably 1 second to 3 minutes. When the heat-treatment temperature is below 200° C., the heat-treatment time is preferably 1 second to 15 minutes, more preferably 5 seconds to 10 minutes, even more preferably 10 seconds to 5 minutes.

The step (II) may be a step (II′) that applies a coating liquid (T) to the layer (Y) obtained in step (III) or to a precursor layer of layer (Y) resulting from step (III-1), and that dries the coating liquid (T) applied to these layers. When the step (III) is followed by step (II′), it is preferable to perform a heat treatment after drying in step (II′), under the same conditions used in step (III). When step (II′) is performed after step (III-1), it is preferable to perform a step (III-2) after drying in step (II′).

Applications

A multilayer structure of the present invention has good barrier properties, and is applicable to a wide range of applications, including packaging materials, electronic-device protective sheets, and damp-proof membranes. The preferred use is for packaging materials and vacuum packaging bags (an envelope of a vacuum insulator) because of good bending resistance. Here, a multilayer structure of the present invention having excellent retort resistance can be deemed as being capable of retaining a good appearance and excellent gas barrier properties even after exposure to severe conditions. Because a multilayer structure of the present invention can exhibit excellent performance (appearance and gas barrier properties) even in severe surrounding environments, a multilayer structure of the present invention can be suitably used as an envelope of a vacuum insulator. A multilayer structure of the present invention can also be suitably used as a protective sheet for electronic devices.

Packaging Material

A packaging material of the present invention may consists of a multilayer structure of the present invention, or may include a multilayer structure of the present invention and other members. For example, the multilayer structure may constitute 50% to 100% of the overall area of the packaging bag. The same applies to the case where the packaging material is in a form other than a packaging bag (a container or lid, for example). A packaging material according to a preferred embodiment of the present invention has barrier properties against inorganic gases (such as hydrogen, helium, nitrogen, oxygen, and carbon dioxide), natural gases, water vapor, and organic compounds that are liquid at ordinary temperature and ordinary pressure (such as ethanol and gasoline vapor).

A packaging material of the present invention can be produced by various methods. For example, a container (packaging material) may be produced by subjecting a sheet of the multilayer structure or a film material including the multilayer structure (such a material will hereinafter be simply referred to as “film material”) to a joining process and thereby forming the sheet of the multilayer structure or the film material into a predetermined container shape. Examples of the method for shaping include thermoforming, injection molding, and extrusion blow molding. Alternatively, a container (packaging material) may be produced by forming a layer (Z) and a layer (Y) on a base (X) that has been formed into a predetermined container shape.

A packaging material according to the present invention is preferably used as a food packaging material. A packaging material according to the present invention can be preferably used not only as a food packaging material but also as a packaging material for packaging any of the following: chemicals such as agrochemicals and pharmaceuticals; medical devices; industrial materials such as machinery components and delicate materials; and garments.

Examples of products using a packaging material of the present invention include a vertical form-fill-seal bag, a vacuum packaging bag, a pouch, a laminated tube container, an infusion bag, a container lid, a paper container, a strip tape, an in-mold labeled container, and a vacuum insulator.

The vertical form-fill-seal bag is a bag produced from a multilayer structure of the present invention (film material) using a vertical form-fill-seal machine (or a vertical form-fill-seal packaging machine as it is also called, for example). A vertical form-fill-seal machine forms a bag, for example, by sealing (bonding) the supplied film materials at the sides and the bottom while holding the film materials to form opposing surfaces, and thereby forming a bag with an open top. After filling the bag with contents supplied from above the bag, the vertical form-fill-seal machine seals the top of the bag, and cuts the bag above the seal before discharging it as a vertical form-fill-seal bag.

The vacuum packaging bag is a bag produced from a multilayer structure of the present invention, and is used with a reduced pressure being present inside the bag. Because of the reduced pressure inside the bag, the film material separating the interior of the vacuum packaging bag from outside typically deforms by contacting the contents of the bag. The contents are typically food products such as corn on the cob (corn), beans, bamboo shoots, potatoes, chestnuts, tea leaves, meat, fish, and confectionery, or may include a core material in the case of vacuum insulator applications.

The pouch is a container that includes a multilayer structure of the present invention (film material) as a barrier by which the interior, where contents are stored, is separated from outside. The pouch is suited for storage of liquid- or slurry-like contents. However, the pouch can also be used to store solid contents. The contents are typically drinks, condiments, liquid foods and other food products, and daily commodities such as detergents and liquid soaps.

The laminated tube container is a container having a body and a discharge portion, where the body is a portion including a multilayer structure of the present invention (laminate film) as a barrier separating the interior of the container from outside, and the discharge portion is a part of tube from which the contents of the container discharge. For example, the body of the laminated tube container has a cylindrical shape with a closed end, and the discharge portion is provided at the other end.

The infusion bag is a bag (container) for storing infusion fluids such as amino acid infusion preparations, electrolyte infusion preparations, carbohydrate infusion preparations, and fat emulsion infusion preparations as contents. The infusion bag may include a plug member, in addition to the body where contents are stored. The infusion bag may have a hanging hole for hanging the bag. In the infusion bag, the film material by which the interior, where infusion fluid is stored, is separated from outside includes a multilayer structure of the present invention.

The container lid includes a film material (a multilayer structure of the present invention) that serves as a part of a barrier that separates the inside and outside of a container by being combined with a container body to form the container. The container lid is combined with the container body so as to seal the opening of the body by heat sealing or by bonding (sealing) with an adhesive, and form a container (a lidded container) having a sealed interior. Typically, the container lid is bonded to the container body at the edges. In this case, a central portion bounded by the edges faces the interior of the container. The body of the container is a shaped body having, for example, a cup or a tray shape, and includes flange and wall portions where the body is sealed to the lid.

The paper container is a container in which the barrier that separates the interior, where contents are stored, from outside includes a paper layer. The paper container is, for example, a gable top or brick container. These shapes have a bottom wall to enable the paper container to stand itself.

The vacuum insulator is a heat insulator including a vacuum packaging bag, and a core material disposed in the interior bounded by the vacuum packaging bag. The interior in which the core material is disposed has a reduced pressure. The core material may be, for example, a powder such as a perlite powder, a fiber material such as glass wool, a resin foam such as urethane foam, a hollow container, or a honeycomb structure. In the vacuum insulator, the vacuum packaging bag that serves as a barrier includes the multilayer structure.

The following examples of layer configurations of a multilayer structure are preferred for vacuum insulators.

(1) Polyolefin layer/ethylene-vinyl alcohol copolymer layer/inorganic deposition layer/polyamide layer/layer (Z)/layer (Y)/polyester layer

(2) Polyolefin layer/inorganic deposition layer/polyester layer/inorganic deposition layer/polyester layer/layer (Z)/layer (Y)/polyester layer

(3) Polyolefin layer/ethylene-vinyl alcohol copolymer layer/inorganic deposition layer/layer (Z)/layer (Y)/polyester layer/layer (Z)/layer (Y)/polyester layer

(4) Polyolefin layer/inorganic deposition layer/polyester layer/layer (Z)/layer (Y)/polyester layer/layer (Z)/layer (Y)/polyester layer

(5) Polyolefin layer/polyamide layer/inorganic deposition layer/polyester layer/layer (Z)/layer (Y)/polyester layer

(6) Polyolefin layer/ethylene-vinyl alcohol copolymer layer/inorganic deposition layer/inorganic deposition layer/polyester layer/layer (Z)/layer (Y)/polyester layer

The gas barrier properties improve, and a decrease of thermal conductivity can be reduced by incorporating the inorganic deposition layer. The polyolefin layer may be replaced with an ethylene-vinyl alcohol copolymer layer. A decrease of thermal conductivity at high temperature can be reduced by replacing the polyolefin layer with an ethylene-vinyl alcohol copolymer layer. When using the foregoing layer configurations as an envelope of a vacuum insulator, it is preferable to arrange the layers in such an orientation that the polyolefin layer is on the inner side (heat sealing layer) and the polyester layer is on the outer side. The foregoing layer configurations are preferred because long-term deterioration of the inner side due to ambient air such as moisture tends to be reduced. The materials that can be used for the foregoing layer configurations are not particularly limited, and the resins and films described in Examples of the present application can be suitably used.

There are cases where the formed product (for example, a vertical form-fill-seal bag) is heat sealed. For heat sealing, it is typically required to dispose a heat-sealable layer on the inner side of the product to be formed, or on both the inner and outer sides of the product to be formed. Typically, fin sealing is employed for sealing of the body when the heat-sealable layer is present only on the inner side of the product (bag) to be formed, whereas the body is typically sealed in a manner similar to envelope sealing when the heat-sealable layer is present on both the inner and outer sides of the product to be formed. The heat-sealable layer is preferably a polyolefin layer.

An electronic-device protective sheet of the present invention comprises a multilayer structure of the present invention, and may consist only of a multilayer structure of the present invention. The electronic-device protective sheet is used to protect an electronic device from the surrounding environment. For example, a protective sheet of the present invention may be disposed on a surface of the sealing material sealing the body of an electronic device by covering its surface. That is, a protective sheet of the present invention is typically disposed on a surface of the body of an electronic device via a sealing material. The body of an electronic device is not particularly limited, and may be, for example, a photoelectric conversion device, an information display device, or a lighting device.

An electronic-device protective sheet of the present invention may include, for example, a surface protection layer disposed on one or both surfaces of the multilayer structure. It is preferable for the surface protection layer to be a layer made of a scratch-resistant resin. A surface protection layer for a device such as a solar cell which may be used outdoors is preferably made of a resin having high weather resistance (e.g., light resistance). For protecting a surface required to permit transmission of light, a surface protection layer having high light transmissivity is preferred. Examples of the material of the surface protection layer (surface protection film) include poly(meth)acrylic acid ester, polycarbonate, polyethylene terephthalate, polyethylene-2,6-naphthalate, polyvinyl fluoride (PVF), polyvinylidene fluoride (PVDF), polytetrafluoroethylene (PTFE), polychlorotrifluoroethylene (PCTFE), ethylene-tetrafluoroethylene copolymer (ETFE), ethylene-chlorotrifluoroethylene copolymer (ECTFE), tetrafluoroethylene-perfluoroalkyl vinyl ether copolymer (PFA), and tetrafluoroethylene-hexafluoropropylene copolymer (FEP). As an example, the protective sheet includes a poly(meth)acrylic acid ester layer disposed on one surface of the multilayer structure.

An additive (e.g., an ultraviolet absorber) may be added to the surface protection layer to increase the durability of the surface protection layer. A preferred example of the surface protection layer having high weather resistance is an acrylic resin layer to which an ultraviolet absorber has been added. Examples of the ultraviolet absorber include, but are not limited to, ultraviolet absorbers based on benzotriazole, benzophenone, salicylate, cyanoacrylate, nickel, or triazine. These additives may be used with other additives, for example, such as a stabilizer, a light stabilizer, and an antioxidant.

A multilayer structure of the present invention can also be used as a damp-proof membrane. For example, in decorative sheet applications, a multilayer structure of the present invention may be bonded to the back surface of a decorative sheet used for a room door panel or other applications. In this way, the decorative sheet can be prevented from warping caused by factors such as moisture absorption and desorption due to temperature and humidity changes in a room.

### EXAMPLES

The following describes the present invention in greater detail by way of Examples. It should be noted that the present invention is in no way limited by the following Examples, and various changes may be made by a person with ordinary skill in the art within the technical idea of the present invention. The following analyses and evaluations were carried out in Examples and Comparative Examples.

The materials used in Examples and Comparative Examples are as follows.

PET12: Biaxially oriented polyethylene terephthalate film; Lumirror™ P60 manufactured by Toray Industries, Inc. under this trade name, average thickness=12 μm

ONY 15: Biaxially oriented nylon film; Emblem™ ONBC manufactured by Unitika Ltd. under this trade name, average thickness=15 μm

CPP 50: Non-oriented polypropylene film; RXC-22 manufactured by Mitsui Chemicals Tohcello, Inc. under this trade name, average thickness=50 μm

CPP 100: Non-oriented polypropylene film; RXC-22 manufactured by Mitsui Chemicals Tohcello, Inc. under this trade name, average thickness=100 μm

PET 50: Polyethylene terephthalate film with improved adhesion to ethylene-vinyl acetate copolymer; SHINEBEAM® Q1A15 manufactured by TOYOBO CO., LTD. under this trade name, average thickness=50 μm

VM-XL: Aluminum deposited biaxially oriented EVOH film; VM-XL manufactured by Kuraray Co., Ltd. under this trade name, average thickness=12 μm

LLDPE 50: Linear low-density polyethylene film; Unilax LS-760C manufactured by Idemitsu Unitech Co., Ltd., average thickness=50 μm

PVA 60-98: Polyvinyl alcohol; Kuraray Poval® 60-98 manufactured by Kuraray Co., Ltd. under this trade name), degree of saponification: 98.0 to 99.0 mol %, viscosity (4%, 20° C.): 54.0 to 66.0 mPa·s

PVA 28-98: Polyvinyl alcohol; Kuraray Poval® 28-98 manufactured by Kuraray Co., Ltd. under this trade name), degree of saponification: 98.0 to 99.0 mol %, viscosity (4%, 20° C.): 25.0 to 31.0 mPa·s

GPTMOS: 3-Glycidoxypropyltrimethoxysilane; LS-2940 manufactured by Shin-Etsu Chemical Co., Ltd. under this trade name)

TC-315: Organotitanium compound (titanium lactate solution); Orgatix TC-315 manufactured by Matsumoto Fine Chemical Co., Ltd. under this trade name, solids concentration 35 to 45%

TMOS: Trimethoxysilane; LS-540 manufactured by Shin-Etsu Chemical Co., Ltd. under this trade name

NTMOS: 3-Aminopropyltrimethoxysilane; KBM-903 manufactured by Shin-Etsu Chemical Co., Ltd. under this trade name

Evaluation Methods

### (1) Measurement of Average Thicknesses of Layer (Y) and Layer (Z)

The multilayer structure obtained in each Example and Comparative Example was cut using a focused ion beam (FIB) to prepare a section for cross-sectional observation. The prepared section was secured to a sample stage with a carbon tape, and was subjected to 65 runs of platinum ion sputtering at an accelerating voltage of 30 kV, 30 seconds for each run. The cross-section of the multilayer structure was observed using a field-emission transmission electron microscope, and the average thickness was calculated for layer (Y) and layer (Z). The measurement conditions are as follows.

Apparatus: JEM-2100F, manufactured by JEOL Ltd.

Accelerating voltage: 200 kV

Magnification: 250,000×

### (2) Measurement of Oxygen Transmission Rate of Multilayer Structure

The multilayer structure obtained in each Example and Comparative Example was installed in an oxygen transmission rate measurement apparatus in such an orientation that the base (X) was on the carrier gas side, and the oxygen transmission rate was measured by an equal pressure method, in compliance with JIS K7126:2006. The measurement conditions are as follows.

Apparatus: MOCON OX-TRAN 2/21, manufactured by MOCON

Temperature: 20° C.

Humidity on oxygen feed side: 85% RH

Humidity on carrier gas side: 85% RH

Carrier gas flow rate: 10 mL/min

Oxygen pressure: 1.0 atm

Carrier gas pressure: 1.0 atm

### (3) Measurement of Moisture Permeability of Multilayer Structure

The multilayer structure obtained in each Example and Comparative Example was installed in a water vapor transmission rate measurement apparatus in such an orientation that the base layer was on the carrier gas side, and the moisture permeability (water vapor transmission rate) was measured by an equal pressure method, in compliance with JIS K71296:2008. The measurement conditions are as follows.

Apparatus: MOCON PERMATRAN W 3/33, manufactured by MOCON

Temperature: 40° C.

Humidity on water vapor feed side: 90% RH

Humidity on carrier gas side: 0% RH

Carrier gas flow rate: 50 mL/min

### (4) Measurement of Oxygen Transmission Rate and Moisture Permeability After Bending

The multilayer structure obtained in each Example and Comparative Example was cut into a 210 mm×297 mm (A4) size, and subjected to 50 cycles of bending with a Gelbo Flex Tester (manufactured by Rigaku Kogyo Co., Ltd.) according to ASTM F-392. After bending, the multilayer structure was measured for oxygen transmission rate and moisture permeability at a central portion, following the evaluation methods (2) and (3) described above.

### (5) Appearance Evaluation After Retorting

Two 12 mm×12 mm sheets were cut out from the multilayer structure obtained in each Example and Comparative Example. The two sheets of multilayer structure were overlaid on the CPP 50 side, and heat sealed on three sides. The remaining side was heat sealed after filling 80 mL of water into the pouch. The pouch was then subjected to retorting (hot water retaining method) under the conditions below. The retort pouch was evaluated as “A” when nowhere on the surfaces of the pouch had appearance defects due to delamination, “B” when appearance defects due to delamination occurred in parts of pouch, and “C” when appearance defects due to delamination occurred throughout the pouch surfaces.

Retorting apparatus: Flavor Ace RSC-60, manufactured by HISAKA WORKS, LTD.

Temperature: 120° C.

Time: 30 minutes

Pressure: 0.15 MPaG

(6) Calculation of Molar Ratio M_{MR}/M_{AI}

A 0.5 g sample of the multilayer structure obtained in each Example and Comparative Example was charged into a platinum crucible. After adding 1 mL of sulfuric acid and 1 mL of nitric acid, the sample was ashed with a hot plate, an electrical heater, a conductive furnace, or the like. After ashing, 0.3 g of lithium tetraborate was added, and the mixture was melted with a high-frequency melting device. After melting, 10 mL of nitric acid was added in two divided portions (5 ml each), and dissolved into the melt. After dissolution, a 100 mL portion was used for quantification of metals present in the multilayer structure by ICP emission spectrometry. The measurement conditions are as follows.

Apparatus: iCAP 6500 Duo, manufactured by Thermo Fisher Scientific Inc.

RF power: 1,150 W

Pump flow rate as a flow rate of auxiliary gas (argon) at 50 rpm: 0.5 L/min

Carrier gas flow rate (argon): 0.7 L/min

Coolant gas: 12 L/min

The metals present in the base (X) were also quantified using the same method described above for the multilayer structure. From the results of quantification, the amount of metals present in layer (Y) and layer (Z) was calculated by subtracting the amount of metal present in the base (X) from the amount of metal present in the multilayer structure. After converting the amount into number of moles, the molar ratio M_{MR}/M_{AI} was calculated as a ratio of the number of moles (M_{MR}) of constituent metal atoms (M_{R}) in the layer (Z) to the number of moles (M_{AI}) of aluminum atoms present in the layer (Y) per unit area.

(7) Calculation of Molar Ratio M_{MR}/M_{C}

The surface of the layer (Z) in the multilayer structure obtained in each Example and Comparative Example was examined by X-ray photoelectron spectroscopy (XPS). For X-ray photoelectron spectroscopy (XPS) analysis, a scanning X-ray photoelectron spectroscopy device (PHI Quantera SXM, manufactured by Ulvac-Phi Incorporated) was used. The surface was analyzed for a 1,000 μm×1,000 μm area in a 1×10⁻⁶ Pa vacuum with data collected at 90°. From the XPS result, the molar ratio M_{MR}/M_{C} was calculated as a ratio of the number of moles (M_{MR}) of constituent metal atoms (M_{R}) in the layer (Z) to the number of moles (M_{C}) of carbon atoms present in the layer (Z). When the surface of the layer (Z) in the composite structure had contamination, the inside of layer (Z) was analyzed by argon sputtering in the analysis.

### (8) Measurement of Infrared Absorption Spectrum

The multilayer structure obtained in each Example and Comparative Example was measured on the layer (Y) side (the opposite side from base (X)) by attenuated total reflection spectroscopy, using a Fourier transformation infrared spectrophotometer. The measurement conditions are as follows.

Apparatus: Spectrum One, manufactured by PerkinElmer, Inc.

Measurement mode: Attenuated total reflection

Measurement region: 800 to 1,400 cm⁻¹

Production Example of Coating Liquid (S-1)

Distilled water in an amount of 230 parts by mass was heated to 70° C. under stirring. Triisopropoxyaluminum in an amount of 88 parts by mass was added dropwise to the distilled water over 1 hour, the liquid temperature was gradually increased to 95° C., and isopropanol generated was distilled off. In this manner, hydrolytic condensation was performed. To the resulting liquid was added 4.0 parts by mass of a 60 mass % aqueous nitric acid solution, and this was followed by stirring at 95° C. for 3 hours to deflocculate agglomerates of particles of the hydrolytic condensate. After that, the liquid was concentrated so that the concentration of solids calculated as aluminum oxide was adjusted to 10 mass %. To 22.50 parts by mass of the solution thus obtained were added 54.29 parts by mass of distilled water and 18.80 parts by mass of methanol. This was followed by stirring to obtain a homogeneous dispersion. Subsequently, 4.41 parts by mass of an 85 mass % aqueous phosphoric acid solution was added dropwise to the dispersion under stirring, with the liquid temperature held at 15° C. After adding 18.80 parts by mass of a methanol solution dropwise, the stirring was continued at 15° C. until the viscosity reached 1,500 mPa·s. This produced the desired product coating liquid (S-1). In the coating liquid (S-1), the molar ratio of aluminum atoms and phosphorus atoms, as expressed by [aluminum atoms]:[phosphorus atoms], was 1.15:1.00.

Production Example of Coating Liquid (T-1)

A methanol solution of GPTMOS was prepared by dissolving 45.45 parts by mass of GPTMOS in 45.45 parts by mass of methanol. With the temperature of the GPTMOS methanol solution held at 10° C. or less, 9.10 parts by mass of 0.2 N hydrochloric acid was added, and the mixture was stirred to allow hydrolysis and condensation reaction at 10° C. for 30 minutes. This produced a solution (T-1-1). Thereafter, 51.48 parts by mass of a 5 wt % aqueous solution of polyvinyl alcohol (PVA 60-98, manufactured by Kuraray Co., Ltd.) was diluted with 28.93 parts by mass of distilled water and 19.36 parts by mass of methanol, and 0.23 parts by mass of the solution (T-1-1) was added under stirring. The mixture was then stirred at room temperature for 30 minutes to give a coating liquid (T-1) having a solids concentration of 2.6%.

Production Example of Coating Liquids (T-2) to (T-4) and Coating Liquids (CT-3) and (CT-4)

Coating liquids (T-2) to (T-4) and coating liquids (CT-3) and (CT-4) were obtained in the same manner as in the preparation of the coating liquid (T-1), except that the hydroxyl group-containing resin (W), the metal compound (R), and the molar ratio M_{MR}/M_{C} were changed as shown in Table 1.

Production Example of Coating Liquid (T-5)

A 5 wt % aqueous solution of polyvinyl alcohol (52.00 parts by mass; PVA 60-98, manufactured by Kuraray Co., Ltd.) was diluted with distilled water (28.44 parts by mass) and methanol (19.46 parts by mass), and 0.15 parts by mass of organotitanium compound TC-315 was added under stirring. The mixture was then stirred at room temperature for 30 minutes to give a coating liquid (T-5) having a solids concentration of 2.6%.

Production Example of Coating Liquids (T-6) to (T-9) and Coating Liquids (CT-5) and (CT-6)

Coating liquids (T-6) to (T-9) and coating liquids (CT-5) and (CT-6) were prepared in the same manner as in the preparation of the coating liquid (T-5), except that the hydroxyl group-containing resin (W), the metal compound (R), and the molar ratio (M_{MR}/M_{C}) were changed as shown in Table 1.

Production Example of Coating Liquid (T-10)

A methanol solution of TMOS was prepared by dissolving 44.83 parts by mass of TMOS in 44.83 parts by mass of methanol. With the temperature of the TMOS methanol solution held at 10° C. or less, 10.34 parts by mass of 0.2 N hydrochloric acid was added, and the mixture was stirred to allow hydrolysis and condensation reaction at 10° C. for 30 minutes. This produced a solution (T-10-1). Thereafter, 51.47 parts by mass of a 5 wt % aqueous solution of polyvinyl alcohol (PVA 60-98, manufactured by Kuraray Co., Ltd.) was diluted with 28.97 parts by mass of distilled water and 19.41 parts by mass of methanol, and 0.15 parts by mass of the solution (T-10-1) was added under stirring. The mixture was then stirred at room temperature for 30 minutes to give a coating liquid (T-10) having a solids concentration of 2.6%.

Production Example of Coating Liquid (T-11)

A methanol solution of NTMOS was prepared by dissolving 44.44 parts by mass of NTMOS in 44.44 parts by mass of methanol. With the temperature of the NTMOS methanol solution held at 10° C. or less, 11.12 parts by mass of 0.2 N hydrochloric acid was added, and the mixture was stirred to allow hydrolysis and condensation reaction at 10° C. for 30 minutes. This produced a solution (T-11-1). Thereafter, 51.73 parts by mass of a 5 wt % aqueous solution of polyvinyl alcohol (PVA 60-98, manufactured by Kuraray Co., Ltd.) was diluted with 28.74 parts by mass of distilled water and 19.44 parts by mass of methanol, and 0.18 parts by mass of the solution (T-11-1) was added under stirring. The mixture was then stirred at room temperature for 30 minutes to give a coating liquid (T-11) having a solids concentration of 2.6%.

Production Example of Coating Liquid (CT-1)

A 5 wt % aqueous solution of polyvinyl alcohol (52.00 parts by mass; PVA 60-98, manufactured by Kuraray Co., Ltd.) was diluted with distilled water (28.44 parts by mass) and methanol (19.46 parts by mass), and the mixture was stirred at room temperature for 30 minutes to give a coating liquid (CT-1) having a solids concentration of 2.6%.

Production Example of Coating Liquid (CT-2)

A coating liquid (CT-2) was prepared in the same manner as in the preparation of the coating liquid (CT-1), except that the hydroxyl group-containing resin (W) was changed as shown in Table 1.

Production Example of Coating Liquid (CT-7)

A methanol solution of TMOS was prepared by dissolving 4.82 parts by mass of tetramethoxysilane (TMOS) in 4.82 parts by mass of methanol. With the temperature of the TMOS methanol solution held at 10° C. or less, 1.11 parts by mass of 0.2 N hydrochloric acid was added, and the mixture was stirred to allow hydrolysis and condensation reaction at 10° C. for 30 minutes. After dilution with 52.58 parts by mass of distilled water, the solution was mixed with 13.00 parts by mass of a 5% aqueous solution of polyvinyl alcohol (PVA 60-98, manufactured by Kuraray Co., Ltd.), 23.49 parts by mass of methanol, and 0.19 parts by mass of GPTMOS by adding these components in this order while stirring the mixture. The mixture was then stirred at room temperature for 30 minutes to give a coating liquid (CT-7) having a solids concentration of 2.6%.

### Example 1

### Example 1-1

A PET 12 (base (X-1)) was prepared as base (X). The coating liquid (S-1) was applied to the base with a bar coater in a thickness that becomes 0.3 μm on average after drying. The film of the applied liquid was dried at 120° C. for 3 minutes, and heat treated at 180° C. for 1 minute to form a precursor layer of layer (Y-1) on the base. Thereafter, the coating liquid (T-1) was applied with a bar coater in a thickness that becomes 0.2 μm on average after drying. The film was then dried at 120° C. for 3 minutes, and heat treated at 210° C. for 1 minute. This produced a multilayer structure (1-1-1) having a configuration of base (X-1)/layer (Y-1)/layer (Z-1). The multilayer structure (1-1-1) was measured for average thicknesses of layer (Y) and layer (Z), and the molar ratios M_{MR}/M_{AI} and M_{MR}/M_{C} were calculated, according to the evaluation methods (1), (6), and (7) described above. The results are presented in Table 1. The multilayer structure (1-1-1) was also measured for infrared absorption spectrum according to the evaluation method (8). The measurement yielded a maximum absorption wavenumber occurring at 1,108 cm⁻¹ in the 800 to 1,400 cm⁻¹ region.

An adhesive layer was formed on the multilayer structure (1-1-1), and an ONY 15 was laminated on the adhesive layer to obtain a laminate. After forming another adhesive layer on the ONY 15 of the laminate, a CPP 50 was laminated on this adhesive layer, and the laminate was left at 40° C. for 3 days for aging. This produced a multilayer structure (1-1-2) having a configuration of base (X-1)/layer (Y-1)/layer (Z-1)/adhesive layer/ONY 15/adhesive layer/CPP 50. Each of the two adhesive layers was formed by applying the two-component adhesive applied with a bar coater in a thickness that becomes 3 μm on average after drying, and drying the adhesive. Here, the two-component adhesive is a two-component reactive polyurethane adhesive composed of TAKELAC®A-5255 (brand name) and TAKENATE® A-50 (brand name) (both manufactured by Mitsui Chemicals, Inc.).

The multilayer structure (1-1-2) was evaluated for oxygen transmission rate, moisture permeability, oxygen transmission rate and moisture permeability after bending, and appearance after retorting, according to the evaluation methods (2) to (5) described above. The results are presented in Table 1.

### Examples 1-2 to 1-17 and Comparative Examples 1-1 to 1-10

Multilayer structures (1-2-1) to (1-17-1) and (C1-1-1) to (C1-10-1), and multilayer structures (1-2-2) to (1-17-2) and (C1-1-2) to (C1-10-2) were produced and evaluated using the same methods used in Example 1-1, except that the coating liquid (T) and the average thickness of layer (Z) were changed as shown in Table 1. The results are presented in Table 1. The multilayer structures (1-2-1) to (1-17-1) and (C1-1-1) to (C1-10-1) were measured for infrared absorption spectrum according to the evaluation method (8) described above. The measurement yielded a maximum absorption wavenumber occurring at 1,108 cm⁻¹ in the 800 to 1,400 cm⁻¹ region.

### Comparative Example 1-11

A PET12 (base (X-1)) was prepared as base (X). A deposited layer of aluminum, 0.08 μm thick, was formed on the base (X-1) by PVD to obtain an aluminum deposition film, using aluminum as a deposition source. Multilayer structures (C1-11-1) and (C1-11-2) were produced and evaluated using the same methods used in Example 1-1, except that the layer (Z) was laminated on the deposited layer of aluminum. The results are presented in Table 1.

### Comparative Example 1-12

A PET12 (base (X-1)) was prepared as base (X). A deposited layer of aluminum oxide, 0.04 μm thick, was formed on the base (X-1) by PVD to obtain an aluminum oxide deposition film, using aluminum oxide as a deposition source. Multilayer structures (C1-12-1) and (C1-12-2) were produced and evaluated using the same methods used in Example 1-1, except that the layer (Z) was laminated on the deposited layer of aluminum oxide. The results are presented in Table 1.

TABLE 1

| | Multilayer structure | | | | | | | | | |
|---|---|---|---|---|---|---|---|---|---|---|
| | | | | Layer(Z) | | | | | Layer (Y) | |
| | | Layer(Y) | | | | Hydroxyl | | | and layer (Z) | |
| | | | Average | Coating | Average | group- | | | Molar | Molar |
| | | Coating | thickness | (T) | thickness | containing | Compound | | ratio | ratio |
| | Base (X) | liquid (S) | μm | liquid | μm | resin (W) | (R) | W/R | M_{MR}/M_{C} | M_{MR}R/M_{Sl} |
| Ex. 1-1 | PET12 | S-1 | 0.36 | T-1 | 0.2 | PVA60-98 | GPTMOS | 24.6 | 0.0037 | 0.0040 |
| Ex. 1-2 | PET12 | S-1 | 0.36 | T-2 | 0.2 | PVA60-98 | GPTMOS | 4.9 | 0.0184 | 0.0199 |
| Ex. 1-3 | PET12 | S-1 | 0.36 | T-3 | 0.2 | PVA60-98 | GPTMOS | 2.5 | 0.0367 | 0.0397 |
| Ex. 1-4 | PET12 | S-1 | 0.36 | T-4 | 0.2 | PVA60-98 | GPTMOS | 95.9 | 0.0009 | 0.0010 |
| Ex. 1-5 | PET12 | S-1 | 0.36 | T-1 | 0.06 | PVA60-98 | GPTMOS | 24.6 | 0.0037 | 0.0012 |
| Ex. 1-6 | PET12 | S-1 | 0.36 | T-1 | 0.4 | PVA60-98 | GPTMOS | 24.6 | 0.0037 | 0.0079 |
| Ex. 1-7 | PET12 | S-1 | 0.36 | T-1 | 0.2 | PVA28-98 | GPTMOS | 24.6 | 0.0037 | 0.0040 |
| Ex. 1-8 | PET12 | S-1 | 0.36 | T-5 | 0.2 | PVA60-98 | TC-315 | 39.4 | 0.0046 | 0.0023 |
| Ex. 1-9 | PET12 | S-1 | 0.36 | T-6 | 0.2 | PVA60-98 | TC-315 | 19.7 | 0.0092 | 0.0046 |
| Ex. 1-10 | PET12 | S-1 | 0.36 | T-7 | 0.2 | PVA60-98 | TC-315 | 9.9 | 0.0185 | 0.0091 |
| Ex. 1-11 | PET12 | S-1 | 0.36 | T-8 | 0.2 | PVA60-98 | TC-315 | 4.9 | 0.0369 | 0.0183 |
| Ex. 1-12 | PET12 | S-1 | 0.36 | T-9 | 0.2 | PVA60-98 | TC-315 | 98.5 | 0.0018 | 0.0009 |
| Ex. 1-13 | PET12 | S-1 | 0.36 | T-5 | 0.06 | PVA60-98 | TC-315 | 39.4 | 0.0046 | 0.0007 |
| Ex. 1-14 | PET12 | S-1 | 0.36 | T-5 | 0.4 | PVA60-98 | TC-315 | 39.4 | 0.0046 | 0.0046 |
| Ex. 1-15 | PET12 | S-1 | 0.36 | T-5 | 0.2 | PVA28-98 | TC-315 | 39.4 | 0.0046 | 0.0023 |
| Ex. 1-16 | PET12 | S-1 | 0.36 | T-10 | 0.2 | PVA60-98 | TMOS | 38.3 | 0.0037 | 0.0040 |
| Ex. 1-17 | PET12 | S-1 | 0.36 | T-11 | 0.2 | PVA28-98 | NTMOS | 32.4 | 0.0037 | 0.0040 |
| Com. Ex. 1-1 | PET12 | S-1 | 0.36 | — | — | — | — | | — | — |
| Com. Ex. 1-2 | PET12 | S-1 | 0.36 | CT-1 | 0.2 | PVA60-98 | — | — | — | — |
| Com. Ex. 1-3 | PET12 | S-1 | 0.36 | CT-2 | 0.2 | PVA28-98 | — | — | — | — |
| Com. Ex. 1-4 | PET12 | S-1 | 0.36 | T-1 | 0.03 | PVA60-98 | GPTMOS | 24.6 | 0.0037 | 0.0003 |
| Com. Ex. 1-5 | PET12 | S-1 | 0.36 | CT-3 | 0.2 | PVA60-98 | GPTMOS | 239.9 | 0.0004 | 0.0004 |
| Com. Ex. 1-6 | PET12 | S-1 | 0.36 | CT-4 | 0.2 | PVA60-98 | GPTMOS | 1.2 | 0.0882 | 0.0792 |
| Com. Ex. 1-7 | PET12 | S-1 | 0.36 | T-5 | 0.03 | PVA60-98 | TC-315 | 39.4 | 0.0046 | 0.0003 |
| Com. Ex. 1-8 | PET12 | S-1 | 0.36 | CT-5 | 0.2 | PVA60-98 | TC-315 | 393.9 | 0.0005 | 0.0002 |
| Com. Ex. 1-9 | PET12 | S-1 | 0.36 | CT-6 | 0.2 | PVA60-98 | TC-315 | 1.6 | 0.1108 | 0.0549 |
| Com. Ex. 1-10 | PET12 | S-1 | 0.36 | CT-7 | 0.2 | PVA60-98 | TMOS | 0.13 | 2.7694 | 2.9939 |
| | | | | | | | GPTMOS | | | |
| Com. Ex. 1-11 | PET12 | Aluminum | 0.36 | T-1 | 0.2 | PVA60-98 | GPTMOS | 24.6 | 0.0037 | 0.0040 |
| | | deposition | | | | | | | | |
| Com. Ex. 1-12 | PET12 | Aluminum | 0.36 | T-1 | 0.2 | PVA60-98 | GPTMOS | 24.6 | 0.0037 | 0.0040 |
| | | oxide | | | | | | | | |
| | | deposition | | | | | | | | |
| | | | | | | Evaluation | | | | |
| | | | | | | Oxygen transmission rate | | Moisture permeability | | |
| | | | | | | Before | After | Before | After | Appearance |
| | | | | | | bending | bending | bending | bending | after |

| | | |
|---|---|---|
| mL/m² · day · atm | g/m² · day | retorting |

| | | | | | |
|---|---|---|---|---|---|
| Ex. 1-1 | 0.1 | 1.9 | 0.2 | 1.0 | A |
| Ex. 1-2 | 0.1 | 2.0 | 0.2 | 1.2 | A |
| Ex. 1-3 | 0.1 | 2.3 | 0.2 | 1.3 | A |
| Ex. 1-4 | 0.1 | 1.9 | 0.2 | 1.0 | B |
| Ex. 1-5 | 0.1 | 2.2 | 0.2 | 1.5 | A |
| Ex. 1-6 | 0.1 | 1.9 | 0.2 | 1.0 | A |
| Ex. 1-7 | 0.1 | 2.2 | 0.2 | 1.3 | A |
| Ex. 1-8 | 0.1 | 1.9 | 0.2 | 1.0 | A |
| Ex. 1-9 | 0.1 | 2.1 | 0.2 | 1.1 | A |
| Ex. 1-10 | 0.1 | 2.2 | 0.2 | 1.2 | A |
| Ex. 1-11 | 0.1 | 2.3 | 0.2 | 1.3 | A |
| Ex. 1-12 | 0.1 | 1.9 | 0.2 | 1.0 | B |
| Ex. 1-13 | 0.1 | 2.4 | 0.2 | 1.3 | A |
| Ex. 1-14 | 0.1 | 1.9 | 0.2 | 1.0 | A |
| Ex. 1-15 | 0.1 | 2.2 | 0.2 | 1.2 | A |
| Ex. 1-16 | 0.1 | 2.5 | 0.2 | 1.3 | B |
| Ex. 1-17 | 0.1 | 1.9 | 0.2 | 1.1 | B |
| Com. Ex. 1-1 | 0.1 | 3.2 | 0.2 | 2.0 | A |
| Com. Ex. 1-2 | 0.1 | 1.8 | 0.2 | 1.0 | C |
| Com. Ex. 1-3 | 0.1 | 1.9 | 0.2 | 1.1 | C |
| Com. Ex. 1-4 | 0.1 | 3.7 | 0.2 | 2.3 | A |
| Com. Ex. 1-5 | 0.1 | 1.9 | 0.2 | 1.0 | C |
| Com. Ex. 1-6 | 0.1 | 3.5 | 0.2 | 2.0 | A |
| Com. Ex. 1-7 | 0.1 | 3.9 | 0.2 | 2.5 | A |
| Com. Ex. 1-8 | 0.1 | 1.9 | 0.2 | 1.0 | C |
| Com. Ex. 1-9 | 0.1 | 3.4 | 0.2 | 1.9 | A |
| Com. Ex. 1-10 | 0.1 | 3.6 | 0.2 | 2.1 | A |
| Com. Ex. 1-11 | 0.3 | 3.7 | 1.1 | 2.9 | A |
| Com. Ex. 1-12 | 0.3 | 3.4 | 0.6 | 2.6 | A |

### Example 2

### Flat Pouch

### Example 2-1

The multilayer structure (1-1-2) produced in Example 1-1 was cut into two 120 mm×120 mm sheets, and the two sheets of multilayer structure were overlaid in such an orientation that the CPP layers were on the inner side. The resulting rectangular laminate was heat sealed on three sides to form a flat pouch (2-1-1). The flat pouch was then filled with 100 mL of water. A retort process (hot water retaining method) conducted for the flat pouch under the same conditions used in Example 1-1 showed that the pouch retained a good appearance with no breakage or delamination.

### Example 3

### Infusion Bag

### Example 3-1

Two 120 mm×100 mm sheets of multilayer structure were cut out from the multilayer structure (1-1-2) produced in Example 1-1. The two sheets of multilayer structure were then overlaid in such an orientation that the CPP layers were on the inner side. The periphery of the resulting laminate was heat sealed, and a spout (plug member) made of polypropylene was attached by heat sealing. This produced an infusion bag (3-1-1). After filling 100 mL of water into the infusion bag (3-1-1), a retort process (hot water retaining method) was conducted under the same conditions used in Example 1-1. The infusion bag retained a good appearance with no breakage or delamination.

### Example 4

### Container Lid

### Example 4-1

A 100 mm-diameter circular piece of multilayer structure was cut out from the multilayer structure (1-1-2) produced in Example 1-1, and was used as a container lid. Separately, a flanged container (Hi-Retoflex® HR78-84 manufactured by Toyo Seikan Co., Ltd. under this trade name) was prepared for use as a container body. This product is a cup-shaped container measuring 30 mm in height and 78 mm in diameter at the top. The container has an open top, and the flange portion formed along the periphery of the open top is 6.5 mm wide. The container is configured as a three-layer laminate of olefin layer/steel layer/olefin layer. The container was filled almost full with water, and the lid was heat sealed to the flange portion to obtain a lidded container (4-1-1). For heat sealing, the lid was disposed in such an orientation that the CPP layer of the lid was in contact with the flange portion. A retort process (hot water retaining method) conducted for the lidded container (4-1-1) under the same conditions used in Example 1-1 showed that the lidded container retained a good appearance with no breakage or delamination.

### Example 5

### In-Mold Labeled Container

### Example 5-1

A two-component adhesive was applied to two sheets of CPP 100 with a bar coater in a thickness that becomes 3 μm after drying on each sheet. Here, the two-component adhesive is a two-component reactive polyurethane adhesive composed of TAKELAC® A-525S and TAKENATE® A-50 (both manufactured by Mitsui Chemicals, Inc.). The two CPP 100 sheets were laminated with the multilayer structure (1-1-1) of Example 1-1, and the resulting laminate was allowed to stand at 40° C. for 3 days for aging. This produced a multilayer label (5-1-1) having a configuration of CPP 100/adhesive layer/base (X-1)/layer (Y-1)/layer (Z-1)/adhesive layer/CPP 100.

The multilayer label (5-1-1) was cut to conform to the shape of the inner wall surface of a female mold member of a mold for forming a container, and attached to the inner wall surface of the female mold member. After pressing a male mold member into the female mold member, molten polypropylene (NOVATEC® EA7A manufactured by Japan Polypropylene Corporation) was injected into the cavity between the male mold member and female mold member at 220° C. The injection molding produced a container (5-1-2) as intended. The container body had a thickness of 700 μm and a surface area of 83 cm². The entire exterior of the container was covered with the multilayer label (5-1-1) overlying the seams, leaving no exterior area that was not covered by the multilayer label (5-1-1). The container (5-1-2) had a good appearance.

### Example 6

### Extrusion Coating Lamination

### Example 6-1

An adhesive layer was formed on the layer (Z-1) of the multilayer structure (1-1-1) of Example 1-1, and a polyethylene resin (having a density of 0.917 g/cm³ and a melt flow rate of 8 g/10 min) was applied on the adhesive layer by extrusion coating lamination at 295° C. to form a layer having a thickness of 20 μm. This produced a laminate (6-1-1) having a configuration of base (X-1)/layer (Y-1)/layer (Z-1)/adhesive layer/polyethylene. The adhesive layer was formed by applying a two-component adhesive with a bar coater in a thickness that becomes 0.3 μm after drying, and drying the adhesive. Here, the two-component adhesive is a two-component reactive polyurethane adhesive composed of TAKELAC® A-3210 and TAKENATE® A-3070 (both manufactured by Mitsui Chemicals, Inc.). A retort process (hot water retaining method) conducted for the laminate (6-1-1) under the same conditions used in Example 1-1 showed that the laminate retained a good appearance with no delamination.

### Example 7

### Influence of Packaged Material

### Example 7-1

The flat pouch (2-1-1) produced in Example 2-1 was filled with 500 mL of a 1.5% aqueous solution of ethanol, and was subjected to a retort process in hot water at 120° C., 2.5 atm for 30 minutes, using a retorting apparatus (Flavor Ace RCS-60, manufactured by HISAKA WORKS, LTD.). The pouch retained a good appearance with no delamination.

### Examples 7-2 to 7-9

A retort process was conducted in the same manner as in Example 7-1, except that 500 mL of various materials was filled into the flat pouch (2-1-1), instead of 500 mL of a 1.5% aqueous solution of ethanol. After retorting, a measurement sample was cut out from the flat pouch, and the oxygen transmission rate of the sample was measured. The packaged materials are a 1.0% aqueous solution of ethanol (Example 7-2), vinegar (Example 7-3), an aqueous solution of citric acid with a pH of 2 (Example 7-4), an edible oil (Example 7-5), ketchup (Example 7-6), soy sauce (Example 7-7), and a ginger paste (Example 7-8). All of these samples had an oxygen transmission rate of 0.2 mL/(m²·day·atm) after retorting. In another retort process conducted in the same manner as in Example 7-1, the lidded container (4-1-1) produced in Example 4-1 was tested with mandarin syrup filling the container almost completely (Example 7-9). The tested lidded container retained a good appearance with no delamination.

As clearly demonstrated in Examples 7-1 to 7-9, the packaging materials of the present invention retained a good appearance even after retorting conducted with various food products.

### Example 8

### Vacuum Insulator

### Example 8-1

The two-component adhesive used in Example 5-1 was applied on a CPP 50 in a thickness that becomes 3 μm after drying, and the adhesive was dried to form an adhesive layer. The CPP 50 was then bonded to the PET layer of the multilayer structure (1-1-1) produced in Example 1-1. This produced a laminate (8-1-1). Separately, the same two-component reactive polyurethane adhesive was applied on an ONY 15 in a thickness that becomes 3 μm after drying, and the adhesive was dried to form an adhesive layer. The ONY 15 was then bonded to the laminate (8-1-1) to obtain a multilayer structure (8-1-2) having a configuration of CPP 50/adhesive layer/base (X)/layer (Y)/layer (Z)/adhesive layer/ONY 15.

The multilayer structure (8-1-2) was cut into two laminates, each measuring 700 mm×300 mm in size. The laminates were overlaid in such an orientation that the CPP layers were on the inner side. These were then heat sealed on three sides with a seal width of 10 mm. This produced a bag sealed on three sides. Thereafter, a heat-insulating core material was filled into the bag through its opening, and the bag was hermetically closed with a vacuum packaging machine at 20° C. with an internal pressure of 10 Pa. This produced a vacuum insulator (8-1-3). A fine silica powder was used as the heat-insulating core material. The vacuum insulator (8-1-3) was left at 40° C., 15% RH for 360 days, and the internal pressure of the vacuum insulator was measured using a Pirani gauge. The measured pressure was 37.0 Pa.

### Example 8-2

The two-component adhesive used in Example 5-1 was applied on the layer (Z) of the multilayer structure (1-1-1) in a thickness that becomes 3 μm after drying, and the adhesive was fried to form an adhesive layer. The multilayer structure (1-1-1) was then bonded to an ONY 15 to obtain a laminate (8-2-1). Thereafter, the same two-component reactive polyurethane adhesive was applied on the ONY 15 of the laminate (8-2-1) in a thickness that becomes 3 μm after drying, and the adhesive was dried to form an adhesive layer. The laminate (8-2-1) was then bonded to the aluminum deposited surface of VM-XL to obtain a laminate (8-2-2). Separately, the two-component reactive polyurethane adhesive was applied on an LLDPE 50 in a thickness that becomes 3 μm after drying, and the adhesive was dried to form an adhesive layer. The LLDPE 50 was then bonded to the VM-XL surface of the laminate (8-2-2) to obtain a multilayer structure (8-2-3) having a configuration of base (X)/layer (Y)/layer (Z)/adhesive layer/ONY 15/adhesive layer/VM-XL/adhesive layer/LLDPE 50.

The multilayer structure (8-2-3) was cut into two laminates, each measuring 200 mm×200 mm in size. The laminates were overlaid in such an orientation that the LLDPE 50 films were on the inner side. These were then heat sealed on three sides with a seal width of 10 mm. This produced a bag sealed on three sides. Thereafter, a heat-insulating core material was filled into the bag through its opening, and the bag was hermetically closed with a vacuum packaging machine at 20° C. with an internal pressure of 10 Pa. This produced a vacuum insulator (8-2-4). A glass fiber was used as the heat-insulating core material . The vacuum insulator (8-2-4) was measured for thermal conductivity before and after being left at 70° C., 90% RH for 2 weeks, using a thermal conductivity measurement device. The measurement yielded a thermal conductivity difference of 4.4 mW/mK before and after storage.

### Example 8-3

The two-component adhesive used in Example 5-1 was applied on the layer (Z) of the multilayer structure (1-1-1) in a thickness that becomes 3 μm after drying, and the adhesive was dried to form an adhesive layer. The multilayer structure (1-1-1) was then bonded to the base (X) side of the laminate (8-2-1) to obtain a laminate (8-3-1). Thereafter, the same two-component reactive polyurethane adhesive was applied on the ONY 15 of the laminate (8-3-1) in a thickness that becomes 3 μm after drying, and the adhesive was dried to form an adhesive layer. The laminate (8-3-1) was then bonded to the aluminum deposited surface of VM-XL to obtain a laminate (8-3-2). Separately, the two-component reactive polyurethane adhesive was applied on an LLDPE 50 in a thickness that becomes 3 μm after drying, and the adhesive was dried to form an adhesive layer. The LLDPE 50 was then bonded to the VM-XL surface of the laminate (8-3-2) to obtain a multilayer structure (8-3-3) having a configuration of base (X)/layer (Y)/layer (Z)/adhesive layer/base (X)/layer (Y)/layer (Z)/adhesive layer/VM-XL/adhesive layer/LLDPE 50.

The multilayer structure (8-3-3) was cut into two laminates, each measuring 200 mm×200 mm in size. The laminates were overlaid in such an orientation that the LLDPE 50 films were on the inner side. These were then heat sealed on three sides with a seal width of 10 mm. This produced a bag sealed on three sides. Thereafter, a heat-insulating core material was filled into the bag through its opening, and the bag was hermetically closed with a vacuum packaging machine at 20° C. with an internal pressure of 10 Pa. This produced a vacuum insulator (8-3-4). A glass fiber was used as the heat-insulating core material. The vacuum insulator (8-3-4) was measured for thermal conductivity before and after being left at 70° C., 90% RH for 2 weeks, using a thermal conductivity measurement device. The measurement yielded a thermal conductivity difference of 3.6 mW/mK before and after storage.

### Example 9

### Protective Sheet

### Example 9-1

An adhesive layer was formed on the multilayer structure (1-1-1) produced in Example 1-1, and an acrylic resin film (thickness: 50 μm) was laminated on the adhesive layer to obtain a laminate. Thereafter, another adhesive layer was formed on the multilayer structure (1-1-1) of the laminate, and a PET 50 was laminated on the laminate. This produced a protective sheet (9-1-1) having a configuration of PET/adhesive layer/base (X-1)/layer (Y-1)/layer (Z-1)/adhesive layer/acrylic resin film. Each of the two adhesive layers was formed by applying the two-component adhesive in a thickness that becomes 3 μm after drying, and drying the adhesive. The two-component adhesive is a two-component reactive polyurethane adhesive composed of TAKE LAC® A-1102 and TAKENATE® A-3070 (both manufactured by Mitsui Chemicals, Inc.).

The protective sheet (9-1-1) was subjected to a durability test (damp heat test). In the test, the protective sheet was stored in an 85° C., 85% RH atmosphere under atmospheric pressure for 1,000 hours using a thermo-hygrostat. The protective sheet (9-1-1) retained a good appearance with no delamination.

1. A multilayer structure comprising a base (X), a layer (Y), and a layer (Z),
the layer (Y) and the layer (Z) being adjacently stacked in at least one pair of the layer (Y) and the layer (Z),
the layer (Y) containing a reaction product (D) of an aluminum atom-containing metal oxide (A) and an inorganic phosphorus compound (BI),
the layer (Z) containing a metal compound (R) containing a metal atom (M_{R}), and a hydroxyl group-containing resin (W),
the molar ratio M_{MR}/M_{AI} of the number of moles (M_{MR}) of metal atoms (M_{R}) to the number of moles (M_{AI}) of aluminum atoms per unit area in the layer (Y) and the layer (Z) being 0.0005 or more and 0.05 or less.

2. The multilayer structure according to claim 1, wherein the hydroxyl group-containing resin (W) has at least a carbon atom, and the molar ratio M_{MR}/M_{C} of the number of moles (M_{MR}) of metal atoms (M_{R}) to the number of moles (Mc) of carbon atoms per unit area in the layer (Z) is 0.0007 or more and 0.07 or less.

3. The multilayer structure according to claim 1, wherein the metal atom (M_{R}) comprises at least one selected from the group consisting of silicon, titanium, and zirconium.

4. The multilayer structure according to claim 1, wherein the metal compound (R) comprises at least one selected from the group consisting of a silicon compound (G) having a glycidyl group, an organotitanium compound (OT), and an organozirconium compound (OZ).

5. The multilayer structure according to claim 4, wherein the silicon compound (G) having a glycidyl group is at least one compound represented by the following general formula (I),
Si(X₁)ₚZ_{q}R_{1(4-p-q)} (I),
wherein X₁ represents one selected from the group consisting of F, Cl, Br, I, R₂O—, R₃COO—, (R₄CO)₂CH—, and NO₃, Z represents an organic group having a glycidyl group, R₁, R₂, R₃, and R₄ each independently represent a group selected from the group consisting of an alkyl group, an aralkyl group, an aryl group, and an alkenyl group, p represents an integer of 1 to 3, q represents an integer of 1 to 3, and 2≤(p+q)≤4, and wherein a plurality of X₁ may be the same or different when a plurality of X₁ exists, a plurality of Z may be the same or different when a plurality of Z exists, and a plurality of R₁ may be the same or different when a plurality of R₁ exists.

6. The multilayer structure according to claim 5, wherein the silicon compound (G) having a glycidyl group is at least one selected from the group consisting of 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, and 2-(3,4-epoxycyclohexyl)ethyltriethoxysilane.

7. The multilayer structure according to claim 4, wherein the organotitanium compound (OT) is at least one selected from the group consisting of an organotitanium alkoxide, an organotitanium acylate, and an organotitanium chelate.

8. The multilayer structure according to claim 4, wherein the organozirconium compound (OZ) is at least one selected from the group consisting of an organozirconium alkoxide, an organozirconium acylate, and an organozirconium chelate.

9. The multilayer structure according to claim 1, wherein the hydroxyl group-containing resin (W) is polyvinyl alcohol.

10. The multilayer structure according to claim 1, wherein the mass ratio (W/R) of the hydroxyl group-containing resin (W) to the metal compound (R) in the layer (Z) is 2.0 or more and 200 or less.

11. The multilayer structure according to claim 1, which comprises a laminate structure in which the base (X), the layer (Y), and the layer (Z) are stacked in this order.

12. The multilayer structure according to claim 1, wherein the layer (Z) has an average thickness of 50 nm or more.

13. The multilayer structure according to claim 1, wherein the ratio (Z)/(Y) of an average thickness of the layer (Z) to an average thickness of the layer (Y) is 0.10 or more.

14. A method for producing a multilayer structure of claim 1, comprising:
a step (I) of applying a coating liquid (S) containing an aluminum atom-containing metal oxide (A), an inorganic phosphorus compound (BI), and a solvent to a base (X), and removing the solvent to form a precursor layer of layer (Y);
a step (II) of applying a coating liquid (T) containing a resin (W), the metal compound (R), and a solvent to the precursor layer of layer (Y), and removing the solvent to form a precursor layer of layer (Z); and
a step (III) of heat treating the precursor layer of layer (Y) and the precursor layer of layer (Z) to form a layer (Y) and a layer (Z).

15. A packaging material comprising a multilayer structure of claim 1.

16. The packaging material according to claim 15, which is a vertical form-fill-seal bag, a vacuum packaging bag, a pouch, a laminated tube container, an infusion bag, a paper container, a strip tape, a container lid, or an in-mold labeled container.

17. A vacuum insulator, wherein
the packaging material of claim 16 is a vacuum packaging bag,
the vacuum packaging bag comprises contents in an interior thereof,
the contents are a core material, and
the interior of the vacuum packaging bag has a reduced pressure.

18. A protective sheet for electronic devices, comprising a multilayer structure of claim 1.
